(19) United States
(12) Patent Application Publication
(10) Pub. No.: US 2026/0059400 A1
(43) Pub. Date: Feb. 26, 2026

(54) Wireless Device, Network Node, and Methods Performed thereby for Handling a Failure in a Mobility Procedure by the Wireless Device

(71) Applicant: Telefonaktiebolaget LM Ericsson (publ), Stockholm (SE)

(72) Inventors: Pradeepa Ramachandra, Linköping (SE); Ali Parichehrehteroujeni, Linköping (SE); Marco Belleschi, Solna (SE)

(21) Appl. No.: 19/105,395

(22) PCT Filed: Aug. 31, 2023
(86) PCT No.: PCT/SE2023/050864

§ 371 Date: Feb. 21, 2025

Related U.S. Application Data
(60) Provisional application No. 63/374,008, filed on Aug. 31, 2022.

(51) Int. Cl. H04W 36/00

(52) U.S. Cl. CPC H04W 36/0079

(57) ABSTRACT

A method, performed by a wireless device (130). The method is for handling a failure in a mobility procedure by the wireless device (130) from a first network node (111) to a second network node (112). The wireless device (130) operates in a wireless communications network (100). The wireless device (130) sends (305), to a third network node (113) serving the wireless device (130) in the wireless communications network (100), one or more indications indicating the failed mobility procedure. The one or more indications comprise at least a first indication. The first indication indicates whether a previous indication that indicated to the wireless device (130) to perform a last completed mobility procedure was received by the wireless device (130) via a Layer 1/Layer 2 operation or via a Layer 3 operation.

### TECHNICAL FIELD

The present disclosure relates generally to a wireless device and methods performed thereby a failure in a mobility procedure by the wireless device from a first network node to a second network node. The present disclosure further relates generally to a network node and methods performed thereby, for handling the mobility procedure by the wireless device from a the first network node to the second network node.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc., . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Further NR Mobility Enhancements in 3GPP Rel-18

As part of 3GPP Release 18, a new work item known as Further NR mobility enhancements is about to start. This work item aims, among others, to specify Layer-1 (L1)/Layer-2 (L2)-based inter-cell mobility. According to the Work Item Description (WID) [1], the following is included as one objective of the work: to specify mechanism and procedures of L1/L2 based inter-cell mobility for mobility latency reduction. This may comprise configuration and maintenance for multiple candidate cells to allow fast application of configurations for candidate cells [RAN2, RAN3]. Mechanism and procedures of L1/L2 based inter-cell mobility for mobility latency reduction may also comprise dynamic switch mechanism among candidate serving cells, including Special cell (SpCell) and Secondary Cell (Scell), for the potential applicable scenarios based on L1/L2 signalling [RAN2, RAN1]. Mechanism and procedures of L1/L2 based inter-cell mobility for mobility latency reduction may further comprise L1 enhancements for inter-cell beam management, including L1 measurement and reporting, and beam indication [RAN1, RAN2]. It was noted that early RAN2 involvement may be necessary, including the possibility of further clarifying the interaction between this point with the previous point. Mechanism and procedures of L1/L2 based inter-cell mobility for mobility latency reduction may also comprise timing Advance management [RAN1, RAN2]. Mechanism and procedures of L1/L2 based inter-cell mobility for mobility latency reduction may further comprise Centralized unit (CU)-Distributed unit (DU) interface signaling to support L1/L2 mobility, if needed [RAN3]. It was noted that Frequency 2 (FR2) specific enhancements are not precluded, if any. It was further noted that the procedure of L1/L2 based inter-cell mobility may be applicable to the following scenarios: Standalone, Carrier Aggregation (CA) and NR-Dual Connectivity (DC) case with serving cell change within one Cell Group (CG), intra-DU case and intra-CU inter-DU case, applicable for Standalone and CA: no new RAN interfaces are expected, both intra-frequency and inter-frequency, both Frequency 1 (FR1) and FR2, and source and target cells may be synchronized or non-synchronized.

According to the work item description [1], the following is written as part of the justification: when the UE moves from the coverage area of one cell to another cell, at some point, a serving cell change may need to be performed. Currently, serving cell change may be triggered by L3 measurements and may be done by Radio Resource Control (RRC) signalling triggered Reconfiguration with Synchronisation for change of Primary Cell (PCell) and Primary Secondary Cell (PSCell), as well as release add for SCells when applicable. All cases may involve complete L2, and L1, resets, leading to longer latency, larger overhead and longer interruption time than beam switch mobility. The goal of L1/L2 mobility enhancements may be understood to be to enable a serving cell change via L1/L2 signalling, in order to reduce the latency, overhead and interruption time.

### Self-Organizing Networks (SON) in 3GPP

A Self-Organizing Network (SON) may be understood to be an automation technology designed to make the planning, configuration, management, optimization and healing of mobile radio access networks simpler and faster. SON functionality and behavior has been defined and specified in generally accepted mobile industry recommendations produced by organizations such as 3rd Generation Partnership Project (3GPP) and the Next Generation Mobile Networks (NGMN).

In 3GPP, the processes within the SON area may be classified into Self-configuration process and Self-optimization process. Self-configuration process may be understood as the process where newly deployed nodes may be configured by automatic installation procedures to get the necessary basic configuration for system operation. This process may work in pre-operational state. Pre-operational state may be understood as the state from when the eNB may be powered up and may have backbone connectivity until the Radio Frequency (RF) transmitter may be switched on.

FIG. 1 is a schematic signalling diagram depicting the ramifications of Self-Configuration/Self-Optimization functionality, according to FIGS. 22.1-1 from 3GPP TS 36.300, v. 17.1.0.

As illustrated in FIG. 1, functions handled in the pre-operational state such as basic setup, and initial radio configuration may be covered by the Self Configuration process. As illustrated in FIG. 1, the Basic Setup (A) functions may comprise: a-1) configuration of Internet Protocol (IP) address and detection of Operations, Administration and Maintenance (OAM), a-2) authentication of eNB/Network (NW), a-3) association to a Gateway (GW), a-4) downloading of eNB software (and operational parameters), etc. The Initial Radio Configuration (B) functions may comprise: b-1) neighbour list configuration, b-2) coverage/capacity related parameter configuration, etc.

The Self-optimization process may be defined as the process where User Equipment (UE) and access node measurements and performance measurements may be used to auto-tune the network. This process may work in operational state. Operational state may be understood as the state where the RF interface may be additionally switched on.

As described in FIG. 1, functions handled in the operational state such as optimization/adaptation, may be covered by the Self Optimization process. As illustrated in FIG. 1, the Optimization/Adaptation (C) functions may comprise: c-1) neighbour list optimization, c-2) coverage and capacity control, etc.

In LTE, support for Self-Configuration and Self-Optimisation may be specified, as described in 3GPP TS 36.300, v. 17.1.0 section 22.2, including features such as Dynamic configuration, Automatic Neighbour Relation (ANR), Mobility load balancing, Mobility Robustness Optimization (MRO), Radio Access Channel (RACH) optimization and support for energy saving.

In NR, support for Self-Configuration and Self-Optimisation may be specified as well, starting with Self-Configuration features such as Dynamic configuration, Automatic Neighbour Relation (ANR) in Rel-15, as described in 3GPP TS 38.300, v. 17.1.0 section 15. In NR Rel-16, more SON features are being specified for NR UEs, including Self-Optimisation features such as Mobility Robustness Optimization (MRO).

### Mobility Robustness Optimization (MRO) in 3GPP

Seamless handovers may be understood to be a key feature of 3GPP technologies. Successful handovers may ensure that the UE may move around in the coverage area of different cells without causing too many interruptions in the data transmission. However, there may be scenarios when the network may fail to handover the UE to the ‘correct’ neighbor cell in time, and in such scenarios, the UE may declare the radio link failure (RLF) or Handover Failure (HOF).

Upon HOF and RLF, the UE may take autonomous actions, such as trying to select a cell and initiate reestablishment procedure so that it may be ensured that the UE is trying to get back as soon as it can, so that it may be reachable again. The RLF may be understood to cause a poor user experience, as the RLF may be declared by the UE only when it may realize that there may be no reliable communication channel, that is, radio link, available between itself and the network. Also, reestablishing the connection may require signaling with the newly selected cell, such as random access procedure, RRC Reestablishment Request, RRC Reestablishment RRC Reestablishment Complete, RRC Reconfiguration and RRC Reconfiguration Complete, and may add some latency, until the UE may be able to exchange data with the network again.

According to the specifications, e.g., 3GPP TS 36.331, v. 17.1.0, the possible causes for the radio link failure may be one of the following: a) expiry of the radio link monitoring related timer T310, b) expiry of the measurement reporting associated timer T312, that is, not receiving the handover command from the network within the duration of this timer despite sending the measurement report when T310 was running, c) upon reaching the maximum number of Radio Link Control (RLC) retransmissions, and d) upon receiving random access problem indication from the Medium Access Control (MAC) entity.

As RLF may be understood to lead to reestablishment, which may degrade performance and user experience, it may be understood to be in the interest of the network to understand the reasons for RLF, and try to optimize mobility related parameters, e.g., trigger conditions of measurement reports, to avoid later RLFs. Before the standardization of MRO related report handling in the network, only the UE was aware of some information associated to how the radio quality looked like at the time of RLF, what was the actual reason for declaring RLF etc. For the 20 network to identify the reason for the RLF, the network may be understood to have needed more information, both from the UE and also from the neighboring base stations.

As part of the MRO approach in LTE, the RLF reporting procedure was introduced in the RRC specification in Rel-9 RAN2 work. That has impacted the RRC specifications, e.g., TS 36.331, v. 17.1.0, in the sense that it was standardized that the UE would log relevant information at the moment of an RLF and later report to a target cell the UE may have succeeded to connect, e.g., after reestablishment. That has also impacted the inter-gNodeB interface, that is, X2AP specifications, e.g., 3GPP TS 36.423, v. 17.1.0, as an eNodeB receiving an RLF report may forward it to the eNodeB where the failure may have been originated.

For the RLF report generated by the UE, its contents have been enhanced with more details in the subsequent releases. The measurements included in the measurement report based on the latest LTE RRC specification [1] may be: a) measurement quantities, such as Reference Signal Received Power (RSRP), Reference Signal Received Quality (RSRQ) of the last serving cell, e.g., PCell, b) measurement quantities of the neighbor cells in different frequencies of different RATs, e.g., Evolved Universal Terrestrial Radio Access (EUTRA), Universal Terrestrial Radio Access (UTRA), Global System for Mobile communications Enhanced Data Rates for GSM Evolution Radio Access Network (GERAN), Code Division Multiple Access 2000 (CDMA2000), c) measurement quantity Received Signal Strength Indicator (RSSI) associated to Wireless Local Area Network (WLAN) Access Points (Aps), d) measurement quantity, e.g., RSSI associated to Bluetooth beacons, e) location information, if available, including location coordinates and velocity, f) globally unique identity of the last serving cell, if available, otherwise the Physical cell identifier (PCI) and the carrier frequency of the last serving cell, g) tracking area code of the PCell, h) time elapsed since the last reception of the ‘Handover command’ message, i) Cell Radio Network Temporary Identifier (C-RNTI) used in the previous serving cell, j) whether or not the UE was configured with a Data Radio Bearer (DRB) having Quality of Service Class Identifier (QCI) value of 1.

After the RLF is declared, the RLF report may be logged and included in the VarRLF-Report and, once the UE may select a cell and succeed with a reestablishment, it may include an indication that it has an RLF report available in the RRC Reestablishment Complete message, to make the target cell aware of that availability. Then, upon receiving an UEInformationRequest message with a flag “rlf-ReportReq-r9” the UE may be required to include the RLF report, e.g., stored in a UE variable VarRLF-Report, as described above, in an UEInformationResponse message and send it to the network.

Based on the RLF report from the UE and the knowledge about in which cell did the UE reestablish itself, the original source cell may be able to deduce whether the RLF was caused due to a coverage hole, or due to handover associated parameter configurations. If the RLF was deemed to be due to handover associated parameter configurations, the original serving cell may further classify the handover related failure as too-early, too-late or handover to wrong cell classes. These handover failure classes are explained in brief below. A first handover failure class may be regarding whether the handover failure occurred due to the ‘too-late handover/mobility’ cases. The original serving cell may classify a handover failure to be ‘too late handover/mobility’ when the original serving cell may fail to send the handover command to the UE associated to a handover towards a particular target cell and if the UE reestablishes itself in this target cell post RLF. An example corrective action from the original serving cell may be to initiate the handover procedure towards this target cell a bit earlier by decreasing the cell individual offset (CIO) towards the target cell that may control when the Information Element (IE) may send the event triggered measurement report that may lead to taking the handover decision.

A second handover failure class may be regarding whether the handover failure occurred due to the ‘too-early handover/mobility’ cases. The original serving cell may classify a handover failure to be ‘too early handover/mobility’ when the original serving cell may be successful in sending the handover command to the UE associated to a handover, however the UE may fail to perform the random access towards this target cell or the UE may declare RLF in the target cell soon afterwards. An example corrective action from the original serving cell may be to initiate the handover procedure towards this target cell a bit later by increasing the cell individual offset (CIO) towards the target cell that may control when the IE may send the event triggered measurement report that may lead to taking the handover decision.

A third handover failure class may be regarding whether the handover failure occurred due to the ‘handover/mobility-to-wrong-cell’ cases. The original serving cell may classify a handover failure to be ‘handover/mobility-to-wrong-cell’ when the original serving cell may intend to perform the handover for this UE towards a particular target cell, but the UE may declare failure or may declare failure shortly after successfully completing the handover and then may reestablish itself in a third cell. A corrective action from the original serving cell may be to initiate the measurement reporting procedure that may lead to handover towards the target cell a bit later by decreasing the CIO towards the target cell, or via initiating the handover towards the cell in which the UE reestablished a bit earlier by increasing the CIO towards the reestablishment cell

Existing methods to handle handover failure may result in wasted resources, such as unnecessary signaling and/or unnecessary delays.

### SUMMARY

As part of the development of embodiments herein, one or more challenges with the existing technology will first be identified and discussed.

For what is in the work item description, WID [1], in 3GPP referred to as L1/L2 based inter-cell mobility, the overall procedure and signaling is still open. A goal of L1/L2 based inter-cell mobility is to reduce latency, overhead and interruption time. The L1/L2 inter-cell mobility decisions may be taken by the source DU, in comparison with the legacy L3 mobility decisions which may have been taken by the source CU-Control Plane (CP). The L1/L2 inter-cell mobility candidates may be expected to be configured in a UE specific way. A UE may have limitations on how many inter-cell mobility candidates it may keep in the memory, e.g., 8 L1/L2 inter-cell mobility candidates, and thus different UEs in the same DU may be configured with different candidate L1/L2 inter-cell mobility candidates depending on the UE's location, mobility characteristics and other parameters.

As indicated in the section entitled “Mobility Robustness Optimization (MRO) in 3GPP”, a handover may be classified as too-early or handover-to-wrong cell if the UE declares failure in the target cell shortly after successfully completing the mobility operation from source cell towards the target cell. Such a classification may be aided by UE measurements in the RLF report, which may include the previous source cell identifier, e.g., previousPCellID in RLFReport, in which the UE may have received a cell change command, and the time of stay, e.g., timeConnFailure in RLFReport, in the target cell of the mobility.

After the standardization of L1/L2 inter-cell mobility, the UE may be instructed to perform cell change either via L1/L2 mobility or via L3 mobility. When the UE may declare a failure after successfully completing either the L1/L2 mobility or L3 mobility, the UE may just store the RLF related information and, based on this RLF related information, it is not possible for the network to deduce whether the last successful mobility was performed by L1/L2 command or L3 command.

Further, there may be other scenarios wherein a L1/L2 mobility was performed after an L3 mobility operation. In such a situation, the existing RLF report may include the previous PCell to be the one in which the L3 mobility was performed and no indication regarding the L1/L2 mobility source. This may end up misleading the network to think that an L3 mobility was performed to enter the cell in which the UE declared the RLF, e.g., the intermediate L1/L2 mobility related operation may go missing.

Certain aspects of the present disclosure and their embodiments may provide solutions to these or other challenges.

According to the foregoing, it is an object of embodiments herein to improve the handling of a failure in a mobility procedure by a wireless device from a first network node to a second network node.

According to a first aspect of embodiments herein, the object is achieved by a method, performed by a wireless device. The method is for handling a failure in a mobility procedure by the wireless device from a first network node to a second network node. The wireless device operates in a wireless communications network. The wireless device sends, to a third network node serving the wireless device in the wireless communications network, one or more indications. The one or more indications indicate the failed mobility procedure. The one or more indications comprise at least a first indication. The first indication indicates whether a previous indication that indicated to the wireless device to perform a last completed mobility procedure was received by the wireless device via Layer 1/Layer 2 (L1/L2) operation or via a Layer 3 (L3) operation.

According to a second aspect of embodiments herein, the object is achieved by a method, performed by the third network node. The method is for handling the failure in the mobility procedure by the wireless device from the first network node to the second network node. The third network node operates in the wireless communications network. The third network node receives from the wireless device, the one or more indications. The one or more indications indicate the failed mobility procedure. The one or more indications comprise at least the first indication. The first indication indicates whether the previous indication that indicated to the wireless device to perform the last completed mobility procedure was received by the wireless device via an L1/L2 operation or via an L3 operation.

According to a third aspect of embodiments herein, the object is achieved by the wireless device. The wireless device may be understood to be for handling the failure in the mobility procedure by the wireless device from the first network node to the second network node. The wireless device is configured to operate in the wireless communications network. The wireless device is configured to send, to the third network node serving the wireless device in the wireless communications network, the one or more indications. The one or more indications are configured to indicate the failed mobility procedure. The one or more indications are configured to comprise at least the first indication. The first indication is configured to indicate whether the previous indication that indicated to the wireless device to perform the last completed mobility procedure was received by the wireless device via an L1/L2, operation or via an L3 operation.

According to a fourth aspect of embodiments herein, the object is achieved by the third network node. The third network node may be understood to be for handling the failure in the mobility procedure by the wireless device from the first network node to the second network node. The third network node is configured to operate in the wireless communications network. The third network node is configured to receive, from the wireless device, the one or more indications configured to indicate the failed mobility procedure. The one or more indications are configured to comprise at least the first indication. The first indication is configured to indicate whether the previous indication that indicated to the wireless device to perform the last completed mobility procedure was received by the wireless device via an L1/L2 operation or via an L3 operation.

By sending the stored one or more indications to the third network node, the wireless device may enable the third network node, after receiving the one or more indications, to identify, based on the first indications, whether the last completed mobility was an L1/L2 triggered mobility or an L3 triggered mobility. For example, based on the one or more indications in embodiments herein, if the concerned mobility operation was deemed to be too early mobility or mobility towards a wrong cell and was initiated by the host, e.g., gNB-DU, of the L1/L2 triggered mobility, then, for example, an RLF report may be forwarded to the corresponding gNB-DU for L1/L2 mobility decision optimization. Based on the one or more indications, if the concerned mobility operation was deemed to be too early mobility or mobility towards a wrong cell and was initiated by the host, e.g., gNB-CU-CP, of the L3 triggered mobility, then, for example, the RLF report may be forwarded to the corresponding gNB-CU-CP for L3 mobility decision optimization.

The network may thereby be enabled to make adjustments to the mobility configuration according to its analysis of the one or more indications. This may in turn result in optimized mobility procedures, with reduced latency, shorter interruptions in communications, and more efficient usage of resources in the wireless communications network making mobility procedures more robust.

### BRIEF DESCRIPTION OF THE DRAWINGS

Examples of embodiments herein are described in more detail with reference to the accompanying drawings, according to the following description.

FIG. 1 is a schematic signalling diagram depicting the ramifications of Self-Configuration/Self-Optimization functionality, according to FIGS. 22.1-1 from 3GPP TS 36.300, v. 17.1.0.

FIG. 2 is a schematic diagram depicting an example of a wireless communications network, according to embodiments herein.

FIG. 3 is a flowchart depicting a method in a wireless device, according to embodiments herein.

FIG. 4 is a flowchart depicting a method in a network node, referred to herein as a “third network node”, according to embodiments herein.

FIG. 5 is a schematic block diagram illustrating two embodiments, in panel a) and panel b), of a wireless device, according to embodiments herein.

FIG. 6 is a schematic block diagram illustrating two embodiments, in panel a) and panel b), of a network node, according to embodiments herein.

FIG. 7 is a flowchart depicting a method in a wireless device, according to examples related to embodiments herein.

FIG. 8 is a flowchart depicting a method in a network node, referred to herein as a “third network node”, according to examples related to embodiments herein.

FIG. 9 shows an example of a communication system 900 in accordance with some embodiments.

FIG. 10 is a block diagram of a host 1000, which may be an embodiment of the host 916 of FIG. 9, in accordance with various aspects described herein.

FIG. 11 shows a communication diagram of a host 1102 communicating via a network node 1104 with a UE 1106 over a partially wireless connection in accordance with some embodiments.

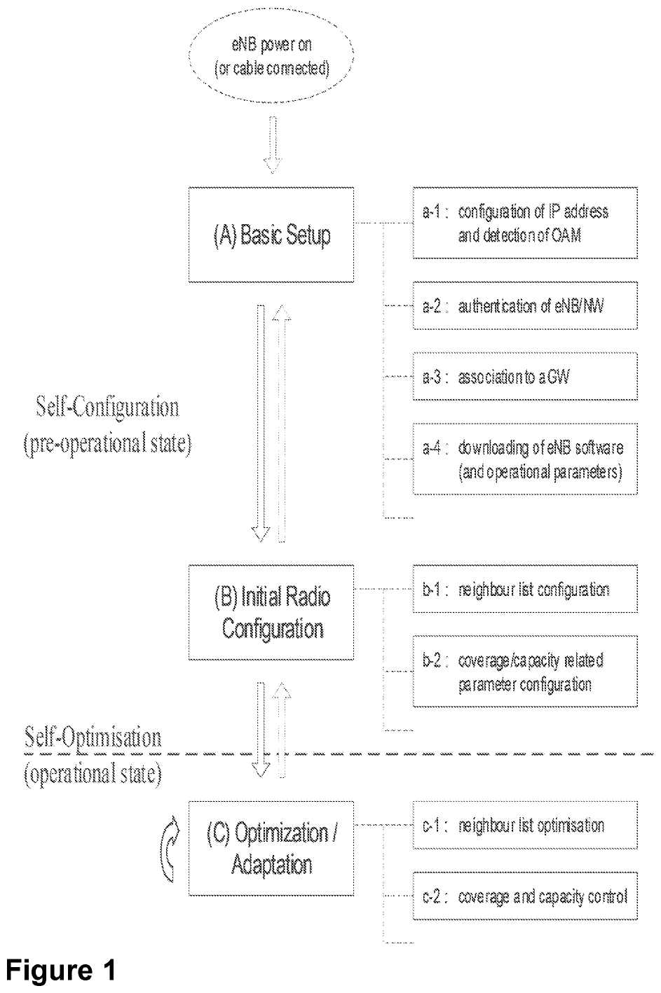

### DETAILED DESCRIPTION

Embodiments herein may be generally understood to relate to HO type information associated to L1/L2 mobility. Embodiments herein may be understood to enable the enhancement of an RLF report with an indication indicating whether the last successfully completed handover was triggered via a L1/L2 based indication, or via the L3 based indication, e.g., an RRCReconfiguration including reconfigurationWithSync.

Embodiments herein may further enable the inclusion of the cell identifier of the cell in which the L1/L2 inter-cell mobility command may have been received, and the time elapsed since the reception of such a command until the failure may have been declared.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

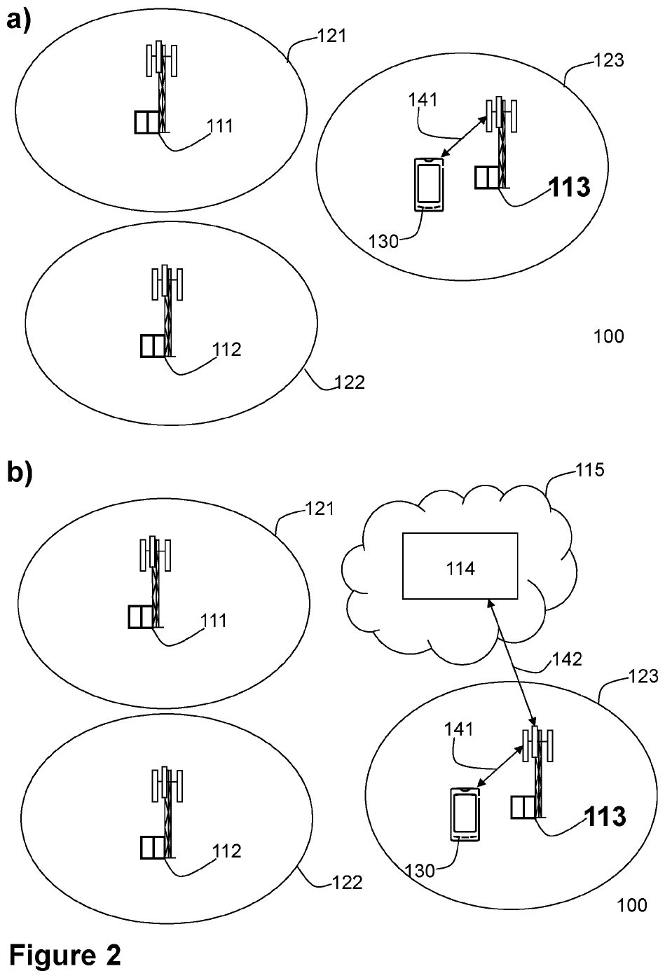

FIG. 2 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may in addition, support other technologies such as, for example, Long-Term Evolution (LTE), e.g., LTE for Machines (LTE-M), LTE Frequency Division Duplex (FDD), LTE Time Division Duplex (TDD), LTE Half-Duplex Frequency Division Duplex (HD-FDD), LTE operating in an unlicensed band, such as LTE Licensed Assisted Access (LAA), enhanced LAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), Machine Type Communication (MTC), enhanced MTC (eMTC), Internet of Things) and/or Narrow Band IoT (NB-IoT) or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a first network node 111, a second network node 112, and a third network node 113 are depicted in the non-limiting example of FIG. 2. Any of the first network node 111, the second network node 112 and the third network node 113 may be a radio network node. That is, a transmission point such as a radio base station, for example a gNB, or an eNB, or any other network node with similar features capable of serving a user equipment, such as a wireless device or a machine type communication device, in the wireless communications network 100. In some examples, such as that depicted in FIG. 2 b for the third network node 113, any of the first network node 111, the second network node 112 and the third network node 113 may be a distributed node, and may partially perform its functions in collaboration with a virtual node 114 in a cloud 115. The third network node 113 may be referred to herein simply as the network node 113.

The wireless communications network 100 may cover a geographical area, which in some embodiments may be divided into cell areas, wherein each cell area may be served by a radio network node, although, one radio network node may serve one or several cells. In the example of FIG. 2, the first network node 111 serves a first cell or source cell 121, the second network node 112 serves a second cell or target cell 122, and the third network node 113 serves a third cell 123, which may be referred to herein simply as the cell 123. Any of the first network node 111, the second network node 112 and the third network node 113 may be of different classes, such as, e.g., macro base station, home base station or pico base station, based on transmission power and thereby also cell size. In some examples, any of the first network node 111, the second network node 112 and the third network node 113 may serve receiving nodes with serving beams. Any of the first network node 111, the second network node 112 and the third network node 113 may support one or several communication technologies, and its name may depend on the technology and terminology used. Any of the radio network nodes that may be comprised in the communications network 100 may be directly connected to one or more core networks, e.g., to one or more network nodes in the one or more core networks.

In some examples, any of the source cell 121, the target cell 122 and the third cell 123 may be served by one or more beams.

In some examples first network node 111, the second network node 112 and the third network node 113 may be different network nodes.

In some examples, any of the first network node 111, the second network node 112 and the third network node 113 may be co-located or be the same node.

A plurality of wireless devices may be located in the wireless communication network 100, whereof a wireless device 130, is depicted in the non-limiting example of FIG. 2. The wireless device 130 comprised in the wireless communications network 100 may be a wireless communication device such as a 5G User Equipment (UE) or nUE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IOT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the third network node 113 over a first link 141, e.g., a radio link. The third network node 113 may be configured to communicate within the wireless communications network 100 with the virtual network node 114 over a second link 142, e.g., a radio link or a wired link. Although not depicted in FIG. 2, the wireless device 130 may be configured to communicate within the wireless communications network 100 with the first network node 111 over a third link, e.g., a radio link, and the wireless device 130 may be configured to communicate within the wireless communications network 100 with the second network node 112 over a fourth link, e.g., a radio link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth” and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a network node, such as the third network node 113, e.g., a gNB.

Some embodiments herein will now be further described with some non-limiting examples.

In the following description, any reference to a/the UE, or simply “UE” may be understood to equally refer the wireless device 130; any reference to a/the gNB, and/or a/the network may be understood to equally refer to the third network node 113.

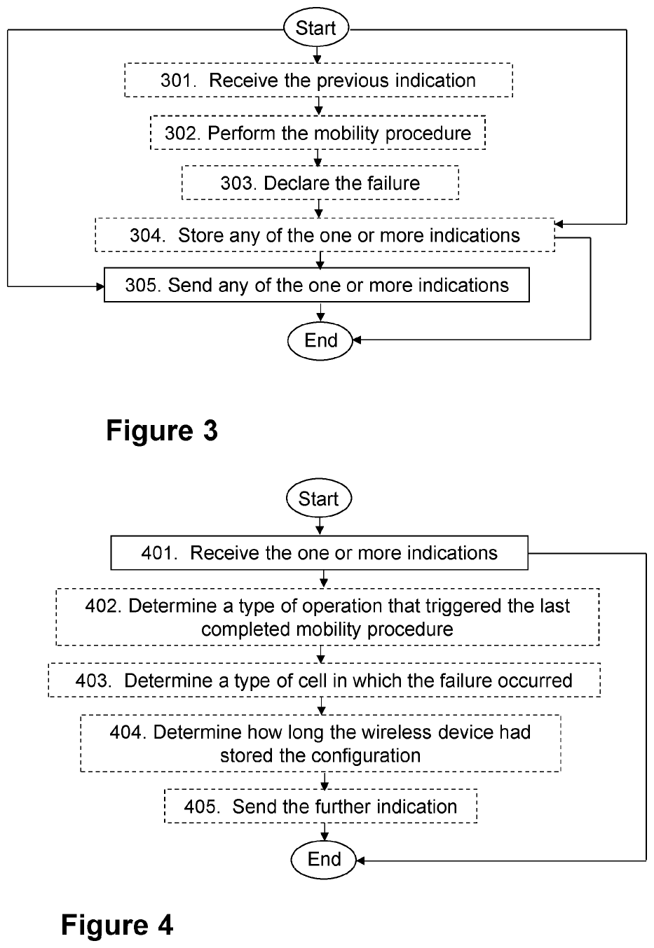

Embodiments of a method, performed by a wireless device, such as the wireless device 130, will now be described with reference to the flowchart depicted in FIG. 3. The method may be understood to be for handling a failure in a mobility procedure by the wireless device 130, e.g., from the first network node 111 to the second network node 112.

The failure may be, e.g., a radio link failure.

A failure in a mobility procedure may be understood herein as that something went wrong in the handling of the mobility, e.g., L1/L2 mobility. For example, something may have gone wrong after receiving the last mobility command, and during or after moving to the second network node 112. The failure in the mobility procedure may be understood to not solely mean that a failure happened during the course of a handover. What may have gone wrong may have been the radio link failure. A mobility procedure may also be referred to herein simply as mobility.

It may be noted, as described above, that the first network node 111 and the second network node 112 may be the same node.

The wireless device 130 operates in a wireless communications network, such as the wireless communications network 100. The method may be understood to be computer-implemented.

In some particular embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 3. In FIG. 3, optional actions in some embodiments may be represented with dashed lines. In some embodiments, the actions may be performed in a different order than that depicted FIG. 3.

In some embodiments, the method may comprise one or more of the following actions 301, 302 and 303, in addition to Action 305.

### Action 301

In this Action 301, the wireless device 130 may receive a previous indication. The previous indication may be to perform a mobility procedure, e.g., L1/L2 inter-cell mobility procedure. That is, the previous indication may be a trigger to perform the mobility procedure. For example, the previous indication may be an L1/L2 inter-cell mobility command.

In some examples, the previous indication may be an indication indicating to perform mobility from the first network node 111 to the second network node 112.

The receiving in this Action 305 may be, e.g., from the first network node 111, from the second network node 112, or from another network node operating in the wireless communications network 100.

This may be understood to mean that the wireless device 130 may receive the previous indication from the same network node to which it may eventually send a report on the failed mobility procedure, although the network node from which it may receive the previous indication may be a different network node.

The receiving in this Action 301 may be via a Layer 1/Layer 2 (L1/L2) operation or via a Layer 3 (L3) operation. That is, the receiving in this Action 301 may be via L1/L2 mobility operation or via L3 mobility operation. For the L1/L2 operations, the previous indication may be received via L1/L2 signalling, e.g., Downlink Control Information (DCI) indication in Physical Downlink Control Channel (PDCCH) for an L1 trigger, MAC Control Element (CE) for an L2 trigger, etc, whereas for the L3 operations, the previous indication may be received via RRC signalling, e.g., RRC reconfigurationWithSync.

### Action 302

In this Action 302, the wireless device 130 may perform the mobility procedure. The mobility procedure may be from the first network node 111 to the second network node 112, e.g., from the source cell 121 to the target cell 122.

The performing in this Action 302 may be, e.g., responsive to the received previous indication. The wireless device 130 may perform the mobility operation successfully towards the second network node 112.

### Action 303

In this Action 303, the wireless device 130 may declare the failure in the mobility procedure. The failure may be, e.g., radio link failure. In other examples, the failure may be a HOF. It may be understood that the failure of embodiments herein may not necessarily take place during the course or attempt of a handover from the source cell 121 to the target cell 122. Occurrence of the radio link failure during such a handover may just be one example of when the radio link failure may happen. As stated earlier, in some examples, any of the first network node 111, the second network node 112 and the third network node 113 may be co-located or be the same node. Accordingly, another example wherein the radio link failure may happen may be in the same cell where the wireless device 130 received the previous indication in Action 301.

In some examples, the wireless device 130 may declare radio link failure in the second network node 112.

A non-limiting example of how the wireless device 130 may declare the failure in this Action 303 may be as described in the Background section according to e.g., 3GPP TS 36.331, v. 17.1.0.

In some embodiments, the method may comprise, additionally to Action 301, Action 302 Action 303 and Action 305, or alternatively to Action 301, Action 302 and Action 303, the following action 304.

### Action 304

In this Action 304, the wireless device 130 may store any of one or more indications. Storing may comprise, e.g., logging or recording. The storing/logging/recording in this Action 304 may be responsive to the declared failure. The one or more indications indicate the failed mobility procedure. That is, the mobility procedure for which the failure may be handled. In other words, the one or more indications may be understood to indicate the failed mobility procedure in the sense of the mobility procedure wherein something went wrong, e.g., during, before or after a handover. In some examples, the wireless device 130, in this Action 304, may store a first set of information associated to the radio link failure in a first report. The first set of information may comprise the one or more indications.

The one or more indications comprise at least a first indication. The first indication may indicate whether the previous indication that indicated to the wireless device 130 to perform a last completed mobility procedure was received by the wireless device 130 via an L1/L2 operation or via an L3 operation. That is, via L1/L2 mobility operation or via L3 mobility operation. As stated earlier, the previous indication may have been received, e.g., from the first network node 111, from the second network node 112, or from another network node operating in the wireless communications network 100. The mobility procedure may be understood to be completed when the wireless device 130 may successfully access the target cell of the mobility procedure.

In some embodiments, the one or more indications may further comprise at least one of the following. According to a first option, the one or more indications may further comprise a second indication. The second indication may indicate the source cell 121 in which the previous indication to perform the last completed mobility procedure, e.g., L1/L2 inter-cell mobility procedure, was received.

According to a second option, the one or more indications may further comprise a third indication. The third indication may indicate a time elapsed between a first time of execution of the last completed mobility procedure, e.g., L1/L2 inter-cell mobility procedure, in Action 302 and a second time when the failure, e.g., radio link failure, in the last completed mobility procedure was declared in Action 303. That is, the third indication may be an indication indicating the time elapsed since the time of execution of the L1/L2 inter-cell mobility, until the time that the radio link failure may be declared.

According to a third option, the one or more indications may further comprise a fourth indication. The fourth indication may indicate whether the target cell 122 in which the last completed mobility procedure, e.g., L1/L2 inter-cell mobility procedure, was executed was a) a secondary cell (SCell), b) a primary secondary cell (PSCell), or c) a non-serving candidate cell, while connected to a source primary cell (Pcell).

According to a fourth option, the one or more indications may further comprise the fourth indication, further indicating the target cell 122 in which the last completed mobility procedure, e.g., L1/L2 inter-cell mobility procedure, was executed was an SCell associated to a Master Cell Group (MCG), or an SCell associated to a Secondary Cell Group (SCG).

According to a fifth option, the one or more indications may further comprise a fifth indication. The fifth indication may indicate whether the wireless device 130 was configured for L1/L2 inter-cell mobility procedure while connected to the target cell 122, e.g., PCell, at the second time when the failure, e.g., radio link failure, in the last completed mobility procedure was declared. In other words, the fifth indication may be an indication indicating whether the wireless device 130 was configured for L1/L2 inter-cell mobility while connected to the target PCell at the time of the failure. This may apply in examples wherein the wireless device 130 may successfully complete a mobility procedure and may then declare RLF in the target cell, and then it may then store an indication indicating that it was configured with L1/L2 configuration while being in the target cell at the time of declaring RLF.

According to a sixth option, the one or more indications may further comprise a sixth indication. The sixth indication may indicate a third time elapsed between a storage of information indicating the last completed mobility procedure, e.g., L1/L2 inter-cell mobility procedure, and the first time of execution of the last completed mobility procedure, e.g., L1/L2 inter-cell mobility procedure, or the second time when the failure, e.g., radio link failure, in the mobility procedure was declared. In other words, the sixth indication may be an indication indicating the time elapsed between the storing of the L1/L2 inter-cell mobility configuration and the execution of the L1/L2 inter-cell mobility, or the failure of the L1/L2 inter-cell mobility. The information indicating the last completed mobility procedure may be a configuration for the mobility procedure.

According to an eighth option, the one or more indications may further comprise a seventh indication. The seventh indication may indicate whether the last completed mobility procedure, e.g., L1/L2 inter-cell mobility procedure, was performed based on a conditional configuration or not. In other words, the seventh indication may be an indication indicating whether the last L1/L2 mobility was performed based on a conditional configuration or not. Conditional configuration may be understood to mean that the wireless device 130 may receive the L1/L2 mobility indication that may have to be triggered based on specific conditions, in a non-limiting example when L1/L2 mobility measurements may meet a certain configured condition.

By storing the one or more indications in this Action 304, the wireless device 130 may then be enabled to send the stored one or more indications to the third network node 113. This may in turn enable the third network node 113 to identify, based on the one or more indications stored in embodiments herein, whether the last completed mobility was a L1/L2 triggered mobility or a L3 triggered mobility. Based on the one or more indications stored in embodiments herein, a corresponding report, e.g., RLF report, as sent in the next Action 305, may be then forwarded to the corresponding entity, for L1/L2 or L3 mobility decision optimization.

The one or more indications stored in embodiments herein may also enable the network to determine whether the cell in which the failure occurred was a serving cell or a non-serving cell while connected to the source cell 121. This method may aid the network to optimize the triggering conditions for the L1/L2 mobility, since in case the failed cell may be a serving cell, the network may also receive from the wireless device 130 Channel State Information (CSI) information, Sounding Reference Signals (SRS), and it may measure the received signaling quality, whereas if the cell is a non-serving cell, the network may have available only L3 measurements. Thus, the network may be enabled to know whether it may need to tune the CSI configuration or the L3 thresholds/offsets.

The network may also be enabled to use some of the above methods to determine for how long the wireless device 130 may have stored the configuration for the L1/L2 mobility associated to a candidate cell of L1/L2 inter-cell mobility. By knowing this information, the network may get to know whether there may have been enough time for the DU to trigger a L1/L2 mobility or whether there may not have been enough time to trigger the L1/L2 mobility from receiving the L1/L2 configuration and declaring the failure. If there was enough time, then the network may need to tune the L1/L2 mobility command triggering conditions, whereas if it was deemed that there was not enough time, then the network may need to send the 11/L2 mobility configurations earlier.

According to its analysis of the one or more indications, the network may thereby be enabled to make adjustments to the mobility configuration. This may in turn result in optimized mobility procedures, with reduced latency, shorter interruptions in communications, and more efficient usage of resources in the wireless communications network 100, making mobility procedures more robust.

### Action 305

In this Action 305, the wireless device 130 sends the one or more indications.

The sending in this Action 305 is to the third network node 113, which may also be referred to simply as the network node 113. The third network node 113 is serving the wireless device 130 in the wireless communications network 100.

As stated earlier, the one or more indications indicate the failed mobility procedure. That is, the mobility procedure for which the failure may be handled.

The one or more indications comprise at least the first indication. As also stated earlier, the first indication indicates whether the previous indication that indicated to the wireless device 130 to perform the last completed mobility procedure was received by the wireless device 130 via the L1/L2 operation or via the L3 operation.

In embodiments herein, the terminology of the PCell related handover and RLF may be used. However, the same principles may be understood to be applicable for the PSCell related changes as well, that is, upon, in Action 303, declaring Secondary Cell Group (SCG) failure after performing a L1/L2 mobility over Secondary Node (SN), the wireless device 130 may be required to include an identifier in the SCGFailureInformation message that may indicate whether the performed mobility was L1/L2 based mobility, further, the triggering method used may also be recorded, that is, whether L1 trigger, e.g., Downlink Control Information (DCI) may have been used or L2 trigger, MAC Control Element (MAC CE), or L3 based mobility.

The sending in this Action 305 may be performed, e.g., via the first link 141.

The sent one or more indications may be the stored one or more indications, e.g., a subset selected from the stored one or more indications.

In some embodiments, at least one of the following options may apply. According to a first option, the one or more indications may be sent in a report, e.g., an RLF report. According to a second option, the one or more indications may be sent in a UEInformationResponse message. According to a third option, the failure may be a radio link failure. According to a fourth option, the mobility procedure, may be an L1/L2 inter-cell mobility procedure. According to a fifth option, the first indication may be indicated by a lastHO-Type information element (IE) set to I1-I2Mobility procedure.

According to a sixth option, the first indication may comprise a lastHO-Type IE set to I1-I2Mobility. In other words, in some examples of embodiments herein, the wireless device 130 may include an indication to indicate whether the last successfully completed mobility operation was a L1/L2 inter-cell mobility operation, e.g., lastHO-Type set to I1-I2Mobility in the example implementation below.

According to a seventh option, with the proviso that the previous indication was received via L1, the first indication may be indicated by an I1-I2Trigger set to I1 Trigger.

According to an eighth option, with the proviso that the previous indication was received via L2, the first indication may be indicated by an I1-I2Trigger IE set to I2Trigger. In other words, some examples of embodiments herein, the wireless device 130 may include an indication to indicate whether the last successfully completed mobility operation was triggered via an L1 mobility indication, e.g., DCI, or via a L2, e.g., MAC CE, mobility indication, e.g., I1-I2Trigger set to 11 Trigger if the trigger was an L1 based indication or I1-I2Trigger set to I2Trigger if the trigger was an L2 based indication in the example implementation below.

According to a ninth option, the second indication may be indicated by a previousL1L2Cell IE. In other words, in some examples of embodiments herein, the wireless device 130 may include the cell identifier of the cell in which the wireless device 130 may have received the L1/L2 inter-cell mobility command, e.g., previousL1L2Cell in the example implementation below.

According to a tenth option, the second indication may indicate, for the source cell 121, at least one of: a physical cell identifier, an operating frequency and a global cell identifier. In other words, in some sub examples, the wireless device 130 may store the physical cell identifier (PCI) and the operating frequency, e.g., Absolute Radio-Frequency Channel number (ARFCN) associated to the (SSBs) and in some other examples, the wireless device 130 may store the global cell identifier (CGI).

According to an eleventh option, the third indication may be indicated by a timeSinceL1L2mobility IE. In other words, in some examples, the wireless device 130 may include the time elapsed since the completion of the L1/L2 inter-cell mobility and the time of declaring RLF, e.g., timeSinceL1L2mobility in the example implementation below.

According to a twelfth option, the fourth indication may be indicated by a previousCellType IE. In other words, in some examples, the wireless device 130 may include an indication previousCellType indicating whether the target cell 122 to which the L1/L2 inter-cell mobility may have been executed was an SCell or a PSCell, or a non-serving candidate cell, while connected to the source Pcell.

According to a thirteenth option, the fifth indication may be indicated by a targetL1L2Configured IE. In other words, in some examples, the wireless device 130 may include an indication targetL1L2Configured indicating whether the wireless device 130 was configured for L1/L2 inter-cell mobility while connected to the PCell in which the failure occurred, e.g., the target PCell of the L1/L2 mobility.

According to a fourteenth option, the sixth indication may be indicated by a timeSinceL1L2Configuration IE. In other words, in some examples, the wireless device 130 may include an indication timeSinceL1L2Configuration indicating the time elapsed between the storing of the L1/L2 inter-cell mobility configuration and the execution of the L1/L2 inter-cell mobility, or the failure of the L1/L2 inter-cell mobility. Separate indications may be provided for the time since the L1/L2 configuration in the source cell 121 and in the target cell 122.

### Example Implementation

An example implementation of the above examples is given below, wherein TS 38.331 v17.0.0 is taken as the baseline. In the example implementation provided, the wireless device 130 is a UE. The third network node 113 may be understood as an example of the network.

The UEInformationResponse message may be used by the UE to transfer information requested by the network.
Signalling radio bearer (SRB): SRB1 or SRB2, (when logged measurement information is included)
RLC-SAP: AM
Logical channel: DCCH
Direction: UE to network

UEInformationResponse message

-- ASN1START
-- TAG-UEINFORMATIONRESPONSE-START

| | |
|---|---|
| UEInformationResponse-r16 ::= | SEQUENCE { |
| rrc-TransactionIdentifier | RRC-TransactionIdentifier, |
| criticalExtensions | CHOICE { |
| ueInformationResponse-r16 | UEInformationResponse-r16-IEs, |
| criticalExtensionsFuture | SEQUENCE { } |

}
}

| UEInformationResponse-r16-IEs ::= | SEQUENCE { | |
|---|---|---|
| measResultIdleEUTRA-r16 | MeasResultIdleEUTRA-r16 | OPTIONAL, |
| measResultIdleNR-r16 | MeasResultIdleNR-r16 | OPTIONAL, |
| logMeasReport-r16 | LogMeasReport-r16 | OPTIONAL, |
| connEstFailReport-r16 | ConnEstFailReport-r16 | OPTIONAL, |
| ra-ReportList-r16 | RA-ReportList-r16 | OPTIONAL, |
| rlf-Report-r16 | RLF-Report-r16 | OPTIONAL, |
| mobilityHistoryReport-r16 | MobilityHistoryReport-r16 | OPTIONAL, |
| lateNonCriticalExtension | OCTET STRING | OPTIONAL, |
| nonCriticalExtension | UEInformationResponse-v1700-IEs | OPTIONAL |

}

| RLF-Report-r16 ::= | CHOICE { | |
|---|---|---|
| nr-RLF-Report-r16 | SEQUENCE { | |
| measResultLastServCell-r16 | MeasResultRLFNR-r16, | |
| measResultNeighCells-r16 | SEQUENCE { | |
| measResultListNR-r16 | MeasResultList2NR-r16 | OPTIONAL, |
| measResultListEUTRA-r16 | MeasResultList2EUTRA-r16 | OPTIONAL |

| | |
|---|---|
| } | OPTIONAL, |
| c-RNTI-r16 | RNTI-Value, |
| previousPCellId-r16 | CHOICE { |
| nrPreviousCell-r16 | CGI-Info-Logging-r16, |
| eutraPreviousCell-r16 | CGI-InfoEUTRALogging |
| } | OPTIONAL, |
| failedPCellId-r16 | CHOICE { |
| nrFailedPCellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
        }
      },
```

| | |
|---|---|
| eutraFailedPCellId-r16 | CHOICE { |
| cellGlobalId-r16 | CGI-InfoEUTRALogging, |
| pci-arfcn-r16 | SEQUENCE { |
| physCellId-r16 | EUTRA-PhysCellId, |
| carrierFreq-r16 | ARFCN-ValueEUTRA |

```
        }
      }
    },
```

| | |
|---|---|
| reconnectCellId-r16 | CHOICE { |
| nrReconnectCellId-r16 | CGI-Info-Logging-r16, |
| eutraReconnectCellId-r16 | CGI-InfoEUTRALogging |

| | |
|---|---|
| } | OPTIONAL, |

| | |
|---|---|
| timeUntilReconnection-r16 | TimeUntilReconnection-r16 |

OPTIONAL,

| | | |
|---|---|---|
| reestablishmentCellId-r16 | CGI-Info-Logging-r16 | OPTIONAL, |
| timeConnFailure-r16 | INTEGER (0..1023) | OPTIONAL, |

| | |
|---|---|
| timeSinceFailure-r16 | TimeSinceFailure-r16 |
| connectionFailureType-r16 | ENUMERATED {rlf, hof}, |
| rlf-Cause-r16 | ENUMERATED {t310-Expiry, randomAccessProblem, rlc- |

MaxNumRetx,

| | beamFailureRecoveryFailure, lbtFailure-r16, | |
|---|---|---|
| | bh-rlfRecoveryFailure, t312-expiry-r17, spare1}, | |
| locationInfo-r16 | LocationInfo-r16 | OPTIONAL, |

| | |
|---|---|
| noSuitableCellFound-r16 | ENUMERATED {true} |

OPTIONAL,

| | |
|---|---|
| ra-InformationCommon-r16 | RA-InformationCommon-r16 |

```
OPTIONAL,
    ...,
    [[
```

| | |
|---|---|
| csi-rsRLMConfigBitmap-v1650 | BIT STRING (SIZE (96)) |

```
OPTIONAL
    ]],
    [[
```

| | |
|---|---|
| lastHO-Type-r17 | ENUMERATED {cho, daps, l1-l2Mobility,l1- |
| l2MobilityConditional spare1} | OPTIONAL, |
| timeConnSourceDAPS-Failure-r17 | TimeConnSourceDAPS-Failure-r17 |

OPTIONAL,

| | |
|---|---|
| timeSinceCHO-Reconfig-r17 | TimeSinceCHO-Reconfig-r17 |

OPTIONAL,

| | |
|---|---|
| choCellId-r17 | CHOICE { |
| cellGlobalId-r17 | CGI-Info-Logging-r16, |
| pci-arfcn-r17 | SEQUENCE { |
| physCellId-r17 | PhysCellId, |
| carrierFreq-r17 | ARFCN-ValueNR |

}

| } | | OPTIONAL, |
|---|---|---|
| choCandidateCellList-r17 | ChoCandidateCellList-r17 | OPTIONAL |

```
    ]],
    [[
```

| | |
|---|---|
| l1-l2Trigger-r17 | ENUMERATED {l1Trigger, l2Trigger, spare2, spare1} |

OPTIONAL,

| | | |
|---|---|---|
| previousL1L2Cell-r17 | CGI-Info-Logging-r16 | OPTIONAL, |
| timeSinceL1L2Mobility-r17 | INTEGER (0..1023) | OPTIONAL, |

| | |
|---|---|
| previousCellType | ENUMERATED {scell, scell_{—}MCG, scell_{—}SCG pscell, |

nonServing, spare1} OPTIONAL,

| | | |
|---|---|---|
| targetL1L2Configured | ENUMERATED {true} | OPTIONAL, |
| timeSinceL1L2Configuration | INTEGER (0..1023) | OPTIONAL |

```
    ]],
  },
```

| | |
|---|---|
| eutra-RLF-Report-r16 | SEQUENCE { |
| failedPCellId-EUTRA | CGI-InfoEUTRALogging, |
| measResult-RLF-Report-EUTRA-r16 | OCTET STRING, |

```
    ...
  }
}
-- TAG-UEINFORMATIONRESPONSE-STOP
-- ASN1STOP
```

RLF-Report field descriptions

choCandidateCellList
This field is used to indicate the list of candidate target cells for conditional handover
(CHO) included in condRRCReconfig at the time of connection failure. The field does not
include the candidate target cells included in measResulNeighCells.
choCellId
This field is used to indicate the candidate target cell for conditional handover included in
condRRCReconfig that the UE selected for CHO based recovery while T311 is running.
connectionFailureType
This field is used to indicate whether the connection failure is due to radio link failure or
handover failure.
csi-rsRLMConfigBitmap, csi-rsRLMConfigBitmap-v1650
These fields are used to indicate the CSI-RS indexes configured in the RLM
configurations for the active BWP when the UE declares RLF or HOF. The UE first fills in
the csi-rsRLMConfigBitmap-r16 to indicate the first 96 CSI-RS indexes and then csi-
rsRLMConfigBitmap-v1650 to indicate the latter 96 CSI-RS indexes. The first/leftmost bit
in csi-rsRLMConfigBitmap-r16 corresponds to CSI-RS index 0, the second bit
corresponds to CSI-RS index 1. The first/leftmost bit in csi-rsRLMConfigBitmap-v1650
corresponds to CSI-RS index 96, the second bit corresponds to CSI-RS index 97. These
fields are included only if the RadioLinkMonitoringConfig for the respective BWP is
configured.
c-RNTI
This field indicates the C-RNTI used in the PCell upon detecting radio link failure or the C-
RNTI used in the source PCell upon handover failure.
failedPCellId
This field is used to indicate the PCell in which RLF is detected or the target PCell of the
failed handover. For intra-NR handover nrFailedPCellId is included and for the handover
from NR to EUTRA eutraFailedPCellId is included. The UE sets the ARFCN according to
the frequency band used for transmission/reception when the failure occurred.
failedPCellId-EUTRA
This field is used to indicate the PCell in which RLF is detected or the source PCell of the
failed handover in an E-UTRA RLF report.
l1-l2Trigger
This field may be used to indicate the type of trigger that was used to perform the L1/L2
mobility. If the UE had performed the last successful L1/L2 inter-cell mobility upon the
reception of a DCI indicating the PCI change then this field may be set to l1Trigger. If the
UE had performed the last successful L1/L2 inter-cell mobility upon the reception of a
MAC CE indicating the PCI change then this field may be set to l2Trigger.
lastHO-Type
This field is used to indicate the type of the last executed handover before the last
detected connection failure. The field is set to cho if the last executed handover was
initiated by a conditional reconfiguration execution. The field is set to daps if the last
executed handover was a DAPS handover. The field may be set to l1-l2Mobility if the last
executed PCell change was triggered by either the L1 or L2 indication associated to the
L1/L2 inter-cell mobility.
measResultListEUTRA
This field refers to the last measurement results taken in the neighboring EUTRA Cells,
when the radio link failure or handover failure happened.
measResultListNR
This field refers to the last measurement results taken in the neighboring NR Cells, when
the radio link failure or handover failure happened or successful handover happened. If
configuration of the conditional handover is available in VarConditionalReconfig when the
radio link failure happened, or if the the last executed RRCReconfiguration message
including reconfigurationWithSync was concerning a conditional handover when the
handover failure or the successful handover happened, the UE uses measResultListNR-
r17, otherwise it uses measResultListNR-r16.
measResultLastServCell
This field refers to the log measurement results taken in the PCell upon detecting radio
link failure or the source PCell upon handover failure.
measResult-RLF-Report-EUTRA
Includes the E-UTRA RLF-Report-r9 IE as specified in TS 36.331 [10].
noSuitableCellFound
This field is set by the UE when the T311 expires.
previousCellType
This field may indicate whether the target cell to which the L1/L2 inter-cell mobility may
have been executed was an SCell or a PSCell, or a non-serving candidate cell, while
connected to the source PCell
previousL1L2Cell
This field may be used to indicate the source cell of the last L1L2 inter-cell mobility
(source cell when the last executed L1/L2 inter-cell mobility command was received).
previousPCellId
This field is used to indicate the source PCell of the last handover (source PCell when the
last executed RRCReconfiguration message including reconfigurationWithSync was
received). For intra-NR handover nrPreviousCell is included and for the handover from
EUTRA to NR eutraPreviousCell is included.
ra-InformationCommon
This field is optionally included when connectionFailureType is set to ‘hof’ or when
connectionFailureType is set to ‘rlf’ and the rlf-Cause equals to ‘randomAccessProblem’ or
‘beamRecoveryFailure’; otherwise this field is absent.
reconnectCellId
This field is used to indicate the cell in which the UE comes back to connected after
connection failure and after failing to perform reestablishment. If the UE comes back to
RRC CONNECTED in an NR cell then nrReconnectCellID is included and if the UE
comes back to RRC CONNECTED in an LTE cell then eutraReconnectCellID is included
reestablishmentCellId
If the UE was not configured with conditionalReconfiguration at the time of re-
establishment attempt, or if the cell selected for the re-establishment attempt is not a
candidate target cell for conditional reconfiguration, this field is used to indicate the cell in
which the re-establishment attempt was made after connection failure.
rlf-Cause
This field is used to indicate the cause of the last radio link failure that was detected. In
case of handover failure information reporting (i.e., the connectionFailureType is set to
‘hof’), the UE is allowed to set this field to any value.
ssbRLMConfigBitmap
This field is used to indicate the SS/PBCH block indexes configured in the RLM
configurations for the active BWP when the UE declares RLF or HOF.The first/leftmost bit
corresponds to SSB index 0, the second bit corresponds to SSB index 1. This field is
included only if the RadioLinkMonitoringConfig for the respective BWP is configured.
targetL1L2Configured
It may indicate whether the UE was configured for L1/L2 inter-cell mobility while
connected to the target PCell at the time of the failure
timeConnFailure
This field is used to indicate the time elapsed since the last HO execution until connection
failure. Actual value = field value * 100 ms. The maximum value 1023 means 102.3 s or
longer.
timeConnSourceDAPS-Failure
This field is used to indicate the time that elapsed between the last DAPS handover
execution and the radio link failure detected in the source cell while T304 is running.
Value in milliseconds. The maximum value 1023 means 1023 ms or longer.
timeSinceFailure
This field is used to indicate the time that elapsed since the connection (radio link or
handover) failure. Value in seconds. The maximum value 172800 means 172800 s or
longer. In the case of failure(s) (either at source or at target or at both) associated to
DAPS handover, this field indicates the time elapsed since the latest connection (radio
link or handover) failure.
timeSinceCHO-Reconfig
In case of handover failure, this field is used to indicate the time elapsed between the
initiation of the last conditional reconfiguration execution towards the target cell and the
reception of the latest conditional reconfiguration for this target cell. In case of radio link
failure, this field is used to indicate the time elapsed between the radio link failure and the
reception of the latest conditional reconfiguration while connected to the source PCell.
Actual value = field value * 100 ms. The maximum value 1023 means 102.3 s or longer.
timeSinceL1L2Configuration
It may indicate the time elapsed between the storing of the L1/L2 inter-cell mobility and
the execution of the L1/L2 inter-cell mobility, or the failure of the L1/L2 inter-cell mobility.
timeSinceL1L2Mobility
This field may be used to indicate the time elapsed since the last L1/L2 inter-cell mobility
until connection failure. Actual value = field value * 100 ms. The maximum value 1023
means 102.3 s or longer.
timeUntilReconnection
This field is used to indicate the time that elapsed between the connection (radio link or
handover) failure and the next time the UE comes to RRC CONNECTED in an NR or
EUTRA cell, after failing to perform reestablishment. Value in seconds. The maximum
value 172800 means 172800 s or longer.

5.3.10.5 RLF report content determination

The UE may be required to determine the content in the VarRLF-Report as follows:

| | |
|---|---|
| 1> | clear the information included in VarRLF-Report, if any; |
| 1> | set the plmn-IdentityList to include the list of EPLMNs stored by the UE (i.e. includes the RPLMN); |

...

| 1> | if the failure is detected due to reconfiguration with sync failure as described in 5.3.5.8.3, set the fields in | |
|---|---|---|
| | VarRLF-report as follows: | |
| | 2> | set the connectionFailureType to hof; |
| | ... | |
| 1> | else if the failure is detected due to Mobility from NR failure as described in 5.4.3.5, set the fields in | |
| | VarRLF-report as follows: | |
| | 2> | set the connectionFailureType to hof; |
| | ... | |
| 1> | else if the failure is detected due to radio link failure as described in 5.3.10.3, set the fields in VarRLF- | |
| | report as follows: | |
| | 2> | set the connectionFailureType to rlf; |
| | 2> | set the rlf-Cause to the trigger for detecting radio link failure in accordance with clause 5.3.10.4; |
| | 2> | set the nrFailedPCellId in failedPCellId to the global cell identity and the tracking area code, if |
| | | available, and otherwise to the physical cell identity and carrier frequency of the PCell where radio link |
| | | failure is detected; |
| | 2> | if the UE had received either an RRCReconfiguration message including the reconfigurationWithSync |

was received before the connection failure or a L1/L2 based inter-cell mobility command was
received before the connection failure:
3> if a L1/L2 based inter-cell mobility command was used to enter the cell in which the radio link

failure was declared:
4> include the previousL1L2Cell and set it to the global cell identity and the tracking area code

of the PCell where the last L1/L2 inter-cell mobility command was received;

4> set lastHO-Type to l1-l2Mobility;
4> set the timeSinceL1L2Mobility to the elapsed time since the execution of the last L1/L2

inter-cell mobility command;

4> set the targetL1L2Configured to true if the UE was configured for L1/L2 inter-cell mobility

in the PCell in which the failure occurred

4> set targetCellType to scell if the PCell in which the failure occurred was an SCell while

connected to the previous source PCell, to PSCell if the PCell in which the failure occurred
was a PSCell while connected to the previous source PCell, to nonServing if the PCell in
which the failure occurred was not a serving cell while connected to the previous source
PCell

4> if L1/L2 mobility is configured at the time of the failure in the PCell in which the failure

occurred:
5> set timeSinceL1L2Configuration to the time elapsed between the configuration of the
L1/L2 mobility and the failure

| | |
|---|---|
| 3> | if the last RRCReconfiguration message including the reconfigurationWithSync concerned an intra |

| NR handover: | |
|---|---|
| 4> | include the nrPreviousCell in previousPCellId and set it to the global cell identity and the |
| | tracking area code of the PCell where the last executed RRCReconfiguration message including |
| | reconfigurationWithSync was received; |
| 4> | if the last executed RRCReconfiguration message including reconfigurationWithSync was |
| | concerning a DAPS handover: |
| | 5> set lastHO-Type to daps; |
| 4> | else if the last executed RRCReconfiguration message including reconfigurationWithSync was |
| | concerning a conditional handover: |
| | 5> set lastHO-Type to cho; |
| 4> | set the timeConnFailure to the elapsed time since the execution of the last RRCReconfiguration |

message including the reconfigurationWithSync;

| | |
|---|---|
| 3> | else if the last RRCReconfiguration message including the reconfigurationWithSync concerned a |

| handover to NR from E-UTRA and if the UE supports Radio Link Failure Report for Inter-RAT | |
|---|---|
| MRO EUTRA: | |
| 4> | include the eutraPreviousCell in previousPCellId and set it to the global cell identity and the |
| | tracking area code of the E-UTRA PCell where the last RRCReconfiguration message including |
| | reconfigurationWithSync was received embedded in E-UTRA RRC message |
| | MobilityFromEUTRACommand message as specified in TS 36.331 [10] clause 5.4.3.3; |
| 4> | set the timeConnFailure to the elapsed time since reception of the last RRCReconfiguration |

message including the reconfigurationWithSync embedded in E-UTRA RRC message
MobilityFromEUTRACommand message as specified in TS 36.331 [10] clause 5.4.3.3;

| | |
|---|---|
| 3> | if configuration of the conditional handover is available in VarConditionalReconfig at the moment |

| of radio link failure: | |
|---|---|
| 3> | set choCandidateCellList to include the global cell identity and tracking area code of all the |

candidate target cells for conditional handover included in condRRCReconfig within
VarConditionalReconfig at the time of radio link failure, excluding the candidate target cells
included in measResulNeighCells;

| | |
|---|---|
| 2> | if configuration of the conditional handover is available in VarConditionalReconfig at the moment of |

| declaring the radio link failure: | |
|---|---|
| 3> | set timeSinceCHO-Reconfig to the time elapsed between the detection of the radio link failure, and |

the reception, in the source PCell, of the last conditionalReconfiguration including the
condRRCReconfig message;

| 1> | if connectionFailureType is rlf and the rlf-Cause is set to randomAccessProblem or | |
|---|---|---|
| | beamFailureRecoveryFailure; or | |
| 1> | if connectionFailureType is hof and if the failed handover is an intra-RAT handover: | |
| | 2> | set the ra-InformationCommon to include the random-access related information as described in clause |

5.7.10.5;

| | |
|---|---|
| 1> | if available, set the locationInfo as in 5.3.3.7. |

The UE may discard the radio link failure information or handover failure information, i.e. release the UE

| | |
|---|---|
| | variable VarRLF-Report, 48 hours after the radio link failure/handover failure is detected |
| NOTE 2: | In this clause, the term ‘handover failure’ has been used to refer to ‘reconfiguration with sync failure’. |

*****************************

In the example implementation, it may be possible that the wireless device 130 may include both previousPCellID+timeConnFailure and the previousL1L2Cell+timeSinceL1L2Mobility fields. In this case for example, the previousPCellID+timeConnFailure may be associated to the last executed L3 mobility, whereas the previousL1L2Cell+timeSinceL1L2Mobility may be associated to the last executed L1/L2 mobility. In some examples, it may be possible that the wireless device 130 may include only one set of them, e.g., if the wireless device 130 uses the L1/L2 mobility command to enter the PCI in which the RLF may be declared then the wireless device 130 may store previousL1L2Cell and timeSinceL1L2Mobility in the RLF report and if the wireless device 130 uses the L3 mobility command to enter the PCI in which the RLF may be declared, then the wireless device 130 may store previousPCellID and timeConnFailure in the RLF report. An example implementation is given below wherein TS 38.331 v17.0.0 is used as the baseline. In yet another example, the wireless device 130 may only include the lastHO-Type-r17 set to I1-I2Mobility and the previousPCelllD+timeConnFailure. If the lastHO-Type-r17 is set to I1-I2Mobility, the previousPCellID and timeConnFailure may represent the previous L1/L2 cell and the time elapsed since the L1/L2 mobility respectively. If the lastHO-Type-r17 is set to cho or daps is not set at all, the previousPCellID and timeConnFailure may represent the previous source cell that triggered the L3 mobility, that is, that transmitted the reconfigurationWithSync, and the time elapsed since the execution of the L3 mobility, that is, execution of the reconfigurationWithSync, respectively.

5.3.10.5 RLF report content determination

The UE may be required to determine the content in the VarRLF-Report as follows:

| | |
|---|---|
| 1> | clear the information included in VarRLF-Report, if any; |
| 1> | set the plmn-IdentityList to include the list of EPLMNs stored by the UE (i.e. includes the |
| | RPLMN); |

...

| 1> | if the failure is detected due to reconfiguration with sync failure as described in 5.3.5.8.3, set the | |
|---|---|---|
| | fields in VarRLF-report as follows: | |
| | 2> | set the connectionFailureType to hof; |
| | ... | |
| 1> | else if the failure is detected due to Mobility from NR failure as described in 5.4.3.5, set the fields | |
| | in VarRLF-report as follows: | |
| | 2> | set the connectionFailureType to hof; |
| | ... | |
| 1> | else if the failure is detected due to radio link failure as described in 5.3.10.3, set the fields in | |
| | VarRLF-report as follows: | |
| | 2> | set the connectionFailureType to rlf; |
| | 2> | set the rlf-Cause to the trigger for detecting radio link failure in accordance with clause |
| | | 5.3.10.4; |
| | 2> | set the nrFailedPCellId in failedPCellId to the global cell identity and the tracking area code, |
| | | if available, and otherwise to the physical cell identity and carrier frequency of the PCell |
| | | where radio link failure is detected; |
| | 2> | if the UE had received either an RRCReconfiguration message including the |

reconfigurationWithSync was received before the connection failure or a L1/L2 based inter-
cell mobility command was received before the connection failure:
3> if a L1/L2 based inter-cell mobility command was used to enter the cell in which the

radio link failure was declared:
4> include the previousL1L2Cell and set it to the global cell identity and the

tracking area code of the PCell where the last L1/L2 inter-cell mobility command
was received;

4> set lastHO-Type to l1-l2Mobility;
4> set the timeSinceL1L2Mobility to the elapsed time since the execution of the last

L1/L2 inter-cell mobility command;

| | |
|---|---|
| 3> | else if the last RRCReconfiguration message including the reconfigurationWithSync |

| concerned an intra NR handover: | |
|---|---|
| 4> | include the nrPreviousCell in previousPCellId and set it to the global cell identity and |
| | the tracking area code of the PCell where the last executed RRCReconfiguration |
| | message including reconfigurationWithSync was received; |
| 4> | if the last executed RRCReconfiguration message including reconfigurationWithSync |
| | was concerning a DAPS handover: |
| | 5> set lastHO-Type to daps; |
| 4> | else if the last executed RRCReconfiguration message including |
| | reconfigurationWithSync was concerning a conditional handover: |
| | 5> set lastHO-Type to cho; |
| 4> | set the timeConnFailure to the elapsed time since the execution of the last |

RRCReconfiguration message including the reconfigurationWithSync;

| | |
|---|---|
| 3> | else if the last RRCReconfiguration message including the reconfigurationWithSync |

| concerned a handover to NR from E-UTRA and if the UE supports Radio Link Failure | |
|---|---|
| Report for Inter-RAT MRO EUTRA: | |
| 4> | include the eutraPreviousCell in previousPCellId and set it to the global cell identity |
| | and the tracking area code of the E-UTRA PCell where the last RRCReconfiguration |
| | message including reconfigurationWithSync was received embedded in E-UTRA RRC |
| | message MobilityFromEUTRACommand message as specified in TS 36.331 [10] clause |
| | 5.4.3.3; |
| 4> | set the timeConnFailure to the elapsed time since reception of the last |

RRCReconfiguration message including the reconfigurationWithSync embedded in E-
UTRA RRC message MobilityFromEUTRACommand message as specified in TS
36.331 [10] clause 5.4.3.3;

| | |
|---|---|
| 3> | if configuration of the conditional handover is available in VarConditionalReconfig at the |

| moment of radio link failure: | |
|---|---|
| 3> | set choCandidateCellList to include the global cell identity and tracking area code of all |

the candidate target cells for conditional handover included in condRRCReconfig within
VarConditionalReconfig at the time of radio link failure, excluding the candidate target
cells included in measResulNeighCells;

| | |
|---|---|
| 2> | if configuration of the conditional handover is available in VarConditionalReconfig at the |

| moment of declaring the radio link failure: | |
|---|---|
| 3> | set timeSinceCHO-Reconfig to the time elapsed between the detection of the radio link |

failure, and the reception, in the source PCell, of the last conditionalReconfiguration
including the condRRCReconfig message;

| 1> | if connectionFailureType is rlf and the rlf-Cause is set to randomAccessProblem or | |
|---|---|---|
| | beamFailureRecoveryFailure; or | |
| 1> | if connectionFailureType is hof and if the failed handover is an intra-RAT handover: | |
| | 2> | set the ra-InformationCommon to include the random-access related information as described |

in clause 5.7.10.5;

| | |
|---|---|
| 1> | if available, set the locationInfo as in 5.3.3.7. |

The UE may discard the radio link failure information or handover failure information, i.e. release the
UE variable VarRLF-Report, 48 hours after the radio link failure/handover failure is detected.

| | |
|---|---|
| NOTE 2: | In this clause, the term ‘handover failure’ has been used to refer to ‘reconfiguration with |
| | sync failure’. |

*****************************

By sending the stored one or more indications to the third network node 113 in this Action 305, the wireless device 130 may enable the network, e.g., the third network node 113, to identify, based on the one or more indications, e.g., based on the additional contents of the RLF report, in embodiments herein, whether the last completed mobility was a L1/L2 triggered mobility or a L3 triggered mobility. Based on the one or more indications in embodiments herein, e.g, the RLF report contents, if the concerned mobility operation was deemed to be too early mobility or mobility towards a wrong cell and was initiated by the host, e.g., gNB-DU, of the L1/L2 triggered mobility, then the RLF report may be forwarded to the corresponding gNB-DU for L1/L2 mobility decision optimization. Based on the RLF report contents, if the concerned mobility operation was deemed to be too early mobility or mobility towards a wrong cell and was initiated by the host, e.g., gNB-CU-CP, of the L3 triggered mobility, then the RLF report may be forwarded to the corresponding gNB-CU-CP for L3 mobility decision optimization.

The one or more indications stored in embodiments herein may also enable the network to determine whether the cell in which the failure occurred was a serving cell or a non-serving cell while connected to the source cell 121. This method may aid the network to optimize the triggering conditions for the L1/L2 mobility, since in case the failed cell may be a serving cell, the network may also receive from the wireless device 130 CSI, SRS, and it may measure the received signaling quality, whereas if the cell is a non-serving cell, the network may have available only L3 measurements.

The network may also be enabled to use some of the above methods to determine for how long the wireless device 130 may have stored the configuration for the L1/L2 mobility associated to a candidate cell.

The network may thereby be enabled to make adjustments to the mobility configuration according to its analysis of the one or more indications. This may in turn result in optimized mobility procedures, with reduced latency, shorter interruptions in communications, and more efficient usage of resources in the wireless communications network 100, making mobility procedures more robust.

Embodiments of a method, performed by a network node, such as the third network node 113, will now be described with reference to the flowchart depicted in FIG. 4. The method may be understood to be for handling the failure in the mobility procedure by the wireless device 130, from the first network node 111 to the second network node 112. The third network node 113, operates in a wireless communications network, such as the wireless communications network 100. The method may be understood to be computer-implemented.

In some embodiments, the wireless communications network 100 may support New Radio (NR).

Several embodiments are comprised herein. The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the third network node 113 is depicted in FIG. 4. In FIG. 4, optional actions in some embodiments may be represented with dashed lines. In some embodiments, the actions may be performed in a different order than that depicted FIG. 4.

The detailed description of some of the following corresponds to the same references provided above, in relation to the actions described for the wireless device 130 and will thus not be repeated here to simplify the description. For example, the failure may be, e.g., a radio link failure.

### Action 401

In this Action 401, the third network node 113 receives, from the wireless device 130, the one or more indications, e.g., the subset of the one or more indications.

The receiving in this Action 401 may be performed, e.g., via the first link 141.

The one or more indications indicate the failed mobility procedure. That is, the mobility procedure for which the failure may be handled.

The one or more indications comprise at least the first indication.

The first indication indicates whether the previous indication that indicated to the wireless device 130 to perform the last completed mobility procedure was received by the wireless device 130 via an L1/L2 operation or via an L3 operation.

The previous indication may have been received, e.g., from the first network node 111, from the second network node 112, or from another network node operating in the wireless communications network 100.

In some embodiments, the one or more indications may further comprise at least one of the following: a) the second indication indicating the source cell 121 in which the previous indication to perform the last completed mobility procedure, e.g., L1/L2 inter-cell mobility procedure, was received, b) the third indication indicating the time elapsed between the first time of execution of the last completed mobility procedure, e.g., L1/L2 inter-cell mobility procedure, and the second time when the failure, e.g., radio link failure, in the last completed mobility procedure was declared, c) the fourth indication indicating whether the target cell 122 in which the last completed mobility procedure, e.g., L1/L2 inter-cell mobility procedure, was executed was a) a secondary cell (SCell), b) a primary secondary cell (PSCell), or c) a non-serving candidate cell, while connected to the source primary cell (Pcell), d) the fourth indication, further indicating the target cell 122 in which the last completed mobility procedure, e.g., L1/L2 inter-cell mobility procedure, was executed was an SCell associated to a Master Cell Group (MCG), or an SCell associated to a Secondary Cell Group (SCG), e) the fifth indication indicating whether the wireless device 130 was configured for L1/L2 inter-cell mobility procedure while connected to the target cell 122, e.g., PCell, at the second time when the failure, e.g., radio link failure, in the last completed mobility procedure was declared, f) the sixth indication indicating the third time elapsed between the storage of information indicating the last completed mobility procedure, e.g., L1/L2 inter-cell mobility procedure, and the first time of execution of the last completed mobility procedure, e.g., L1/L2 inter-cell mobility procedure, or the second time when the failure, e.g., radio link failure, in the mobility procedure was declared, and g) the seventh indication indicating whether the last completed mobility procedure, e.g., L1/L2 inter-cell mobility procedure, was performed based on a conditional configuration or not.

In some embodiments, at least one of the following may apply: a) the one or more indications may be sent in the report, b) the one or more indications may be sent in the UEInformationResponse message, c) the failure may be a radio link failure, d) the mobility procedure may be an L1/L2 inter-cell mobility procedure, e) the first indication may be indicated by the lastHO-Type information element (IE), e.g., set to I1-I2Mobility procedure, f) the first indication may comprise the lastHO-Type IE, e.g., set to I1-I2Mobility, g) with the proviso the previous indication was received via L1, the first indication may be indicated by the I1-I2Trigger set to I1Trigger, h) with the proviso that the previous indication was received via L2, the first indication may be indicated by the I1-I2Trigger IE set to I2Trigger, i) the second indication may be indicated by the previousL1L2Cell IE, j) the second indication may indicate, for the source cell 121, at least one of: the physical cell identifier, the operating frequency and the global cell identifier, k) the third indication may be indicated by the timeSinceL1L2mobility IE, l) the fourth indication may be indicated by the previousCellType IE, m) the fifth indication may be indicated by the targetL1L2Configured IE, and n) the sixth indication may be indicated by the timeSinceL1L2Configuration IE.

In some embodiments, the method may further comprise one or more of the Action 402 and Action 405.

### Action 402

In this Action 402, third network node 113 may determine a type of operation that triggered the last completed mobility procedure, e.g., whether the last completed mobility procedure was triggered by the L1/L2 operation or by the L3 operation.

### Determining May Comprise Calculating, Checking, Deriving, Etc.

The determining in this Action 402 may be based on the received one or more indications, e.g., the received subset of the one or more indications. For example, the determining in this Action 402 may be based on the first indication. As stated earlier, with the proviso the previous indication was received via L1, the first indication may be indicated by the I1-I2Trigger set to I1Trigger, and with the proviso that the previous indication was received via L2, the first indication may be indicated by the I1-I2Trigger IE set to I2Trigger.

In some embodiments, the method may further comprise one or more additional determinations of Action 403 and Action 404.

### Action 403

In this Action 403, third network node 113 may determine a type of cell in which the failure occurred, e.g., whether a cell in which the failure occurred was a serving cell or a non-serving cell while connected to the source cell 121. For example, the determining in this Action 403 may be based on the fourth indication. As stated earlier, the fourth indication may indicate whether the target cell 122 in which the last completed mobility procedure, e.g., L1/L2 inter-cell mobility procedure, was executed was a) an SCell, b) a PSCell, or c) a non-serving candidate cell, while connected to the Pcell. In some embodiments, the fourth indication may further indicate the target cell 122 in which the last completed mobility procedure, e.g., L1/L2 inter-cell mobility procedure, was executed was an SCell associated to an MCG, or an SCell associated to an SCG. In particular examples, the determining in this Action 403 may be performed based on the fourth indication indicated by the previousCellType IE.

### Action 404

In this Action 404, third network node 113 may determine how long the wireless device 130 had stored a configuration for the last completed mobility procedure, e.g., L1/L2 inter-cell mobility, associated to a candidate cell. For example, the determining in this Action 404 may be based on the sixth indication. As stated earlier, the sixth indication may indicate the third time elapsed between the storage of the information indicating the last completed mobility procedure, e.g., L1/L2 inter-cell mobility procedure, and the first time of execution of the last completed mobility procedure, e.g., L1/L2 inter-cell mobility procedure, or the second time when the failure, e.g., radio link failure, in the mobility procedure was declared. The sixth indication may be indicated by the timeSinceL1L2Configuration IE. The candidate cell may be understood as the cell towards which the mobility procedure may have been performed. In the case of RLF in the source cell itself, the candidate cell may be the cell(s) included in the last received L1/L2 configuration.

### Action 405

In this Action 405, third network node 113 may send a further indication.

The sending in this Action 405 may be to e.g., another network node, e.g., another radio network node or a core network node, operating in the wireless communications network 100.

The sending in this Action 405 may be, e.g., based on a result of the determination performed in Action 402.

The further indication may be of the failed mobility to an entity managing the operation, out of the L1/L2 operation and the L3 operation, that may have triggered the last completed mobility.

In some embodiments, at least one of the following may apply: a) with the proviso that the last completed mobility was triggered by the L1/L2 operation, the entity may be a distributed unit (DU) comprised in the third network node 113, and b) with the proviso that the last completed mobility was triggered by the L3 operation, the entity may be a central unit (CU) comprised in the third network node 113.

In some embodiments, the sending in Action 405 of the further indication may further comprise one or more additional indications indicating a result of the one or more additional determinations 403, 404.

As a summarized overview of the foregoing, non-limiting examples of embodiments disclosed herein may relate to a method performed by the wireless device 130, e.g., a UE, the method comprising: a) receiving an indication indicating to perform mobility from the first network node 111 to the second network node 112, b) performing the mobility operation successfully towards the second network node 112, c) declaring radio link failure in the second network node 112, d) storing a first set of information associated to the radio link failure in a first report, the first set of information including one or more of: i) an indication indicating whether the indication that indicated to perform the last completed mobility was sent via L1/L2 (mobility) operation or via L3 (mobility) operation, wherein for the L1/L2 operations, the indication may be sent via L1/L2 signalling, e.g., DCI indication in PDCCH, MAC CE, etc, whereas for the L3 operations the indication may be sent via RRC signalling, e.g., RRC reconfigurationWithSync, ii) an indication indicating the source cell in which the indication to perform the last completed L1/L2 inter-cell mobility was sent, iii) an indication indicating the time elapsed since the time of execution of the L1/L2 inter-cell mobility, until the time that the radio link failure may be declared, iv) an indication indicating whether the target cell 122 to which the L1/L2 inter-cell mobility may be executed was an SCell or a PSCell, or a non-serving candidate cell, while connected to the source Pcell; In an example, the indication may indicate whether the target cell 122 in which the L1/L2 mobility was executed was a SCell associated to the Master Cell Group (MCG) or an SCell associated to the SCG, v) an indication indicating whether the wireless device 130 was configured for L1/L2 inter-cell mobility while connected to the target PCell at the time of the failure; vi) an indication indicating the time elapsed between the storing of the L1/L2 inter-cell mobility and the execution of the L1/L2 inter-cell mobility, or the failure of the L1/L2 inter-cell mobility; and vii) an indication indicating whether the last L1/L2 mobility was performed based on a conditional configuration or not. Conditional configuration may be understood to mean the wireless device 130 may receive the L1/L2 mobility indication that may have to be triggered based on specific conditions, in a non-limiting example when L1/L2 mobility measurements may meet a certain configured condition

Certain embodiments disclosed herein may provide one or more of the following technical advantage(s), which may be summarized as follows.

Embodiments herein, may be understood to enable the network to identify, based on the additional contents of the RLF report as proposed in embodiments herein, whether the last completed mobility was a L1/L2 triggered mobility or a L3 triggered mobility. Based on the RLF report contents, if the concerned mobility operation was deemed to be too early mobility or mobility towards a wrong cell and was initiated by the host, e.g., gNB-DU, of the L1/L2 triggered mobility, then the RLF report may be forwarded to the corresponding gNB-DU for L1/L2 mobility decision optimization. Based on the RLF report contents, if the concerned mobility operation was deemed to be too early mobility or mobility towards a wrong cell and was initiated by the host, e.g., gNB-CU-CP, of the L3 triggered mobility, then the RLF report may be forwarded to the corresponding gNB-CU-CP for L3 mobility decision optimization.

The network may also determine whether the cell in which the failure occurred was a serving cell or a non-serving cell while connected to the source cell. This method may aid the network to optimize the triggering conditions for the L1/L2 mobility, since in case the failed cell is a serving cell, the network may also receive from the UE Channel State Information (CSI) information, Sounding Reference Signals (SRS), and it may measure the received signaling quality, whereas if the cell is a non-serving cell, the network may have available only L3 measurements.

The network may also use some of the above methods to determine for how long the UE may have stored the configuration for the L1/L2 mobility associated to a candidate cell. This may enable the network to know whether to tune the L1/L2 mobility triggering condition, or to tune when to configure the L1/L2 inter-cell mobility configuration.

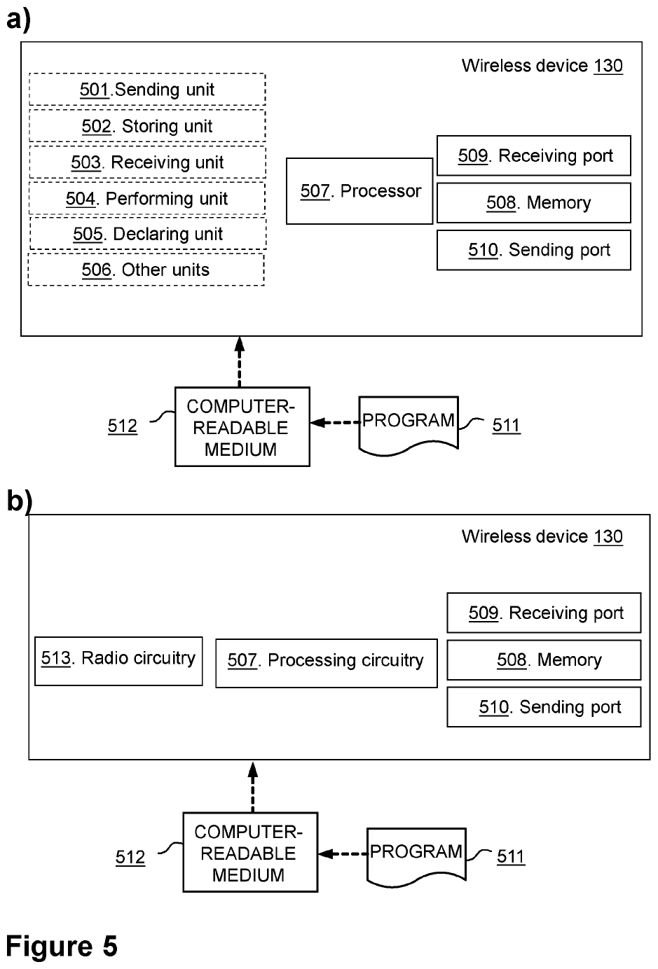

FIG. 5 depicts two different examples in panels a) and b), respectively, of the arrangement that the wireless device 130 may comprise to perform the method actions described above in relation to FIG. 3. In some embodiments, the wireless device 130 may comprise the following arrangement depicted in FIG. 5a. The wireless device 130 may be understood to be for handling the failure in the mobility procedure by the wireless device 130 from the first network node 111 to the second network node 112. The wireless device 130 may be configured to operate in the wireless communications network 100.

In some embodiments, the wireless communications network 100 may be configured to support New Radio (NR).

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the failure may be configured to be, e.g., a radio link failure.

In FIG. 5, optional units are indicated with dashed boxes.

The wireless device 130 may be configured to perform the sending of Action 305, e.g., by means of a sending unit 501 within the wireless device, configured to send, to the third network node 113 serving the wireless device 130 in the wireless communications network 100, the one or more indications configured to indicate the failed mobility procedure. The one or more indications are configured to comprise at least the first indication configured to indicate whether the previous indication that indicated to the wireless device 130 to perform the last completed mobility procedure was received by the wireless device 130 via a L1/L2, operation or via an L3 operation.

In some embodiments, the one or more indications may be further configured to comprise at least one of: a) the second indication configured to indicate the source cell 121 in which the previous indication to perform the last completed mobility procedure was received, b) the third indication configured to indicate the time elapsed between the first time of execution of the last completed mobility procedure and the second time when the failure in the last completed mobility procedure was declared, c) the fourth indication configured to indicate whether the target cell 122 in which the last completed mobility procedure was executed was a) an SCell, b) a PSCell, or c) a non-serving candidate cell, while connected to the source Pcell, and d) the fourth indication, further configured to indicate the target cell 122 in which the last completed mobility procedure was executed was an SCell associated to an MCG, or an SCell associated to an SCG, d) the fifth indication configured to indicate whether the wireless device 130 was configured for L1/L2 inter-cell mobility procedure while connected to the target cell 122 at the second time when the failure in the last completed mobility procedure was declared, e) the sixth indication configured to indicate the third time elapsed between the storage of information indicating the last completed mobility procedure and the first time of execution of the last completed mobility procedure or the second time when the failure in the mobility procedure was declared, and f) the seventh indication configured to indicate whether the last completed mobility procedure was performed based on the conditional configuration or not.

In some embodiments, at least one of the following may apply: a) the one or more indications may be configured to be sent in the report, b) the one or more indications may be configured to be sent in the UEInformationResponse message, c) the failure may be configured to be the radio link failure, d) the mobility procedure may be configured to be the L1/L2 inter-cell mobility procedure, e) the first indication may be configured to be indicated by the lastHO-Type IE set to I1-I2Mobility, f) the first indication may be configured to comprise the lastHO-Type IE set to I1-I2Mobility, g) with the proviso the previous indication was received via L1, the first indication may be configured to be indicated by the I1-I2Trigger set to I1Trigger, h) with the proviso the previous indication was received via L2, the first indication may be configured to be indicated by the I1-I2Trigger IE set to I2Trigger, i) the second indication may be configured to be indicated by the previousL1L2Cell IE, j) the second indication may be configured to indicate, for the source cell 121, at least one of: the physical cell identifier, the operating frequency and the global cell identifier, k) the third indication may be configured to be indicated by the timeSinceL1L2mobility IE, l) the fourth indication may be configured to be indicated by the previousCellType IE, m) the fifth indication may be configured to be indicated by the targetL1L2Configured IE, and n) the sixth indication may be configured to be indicated by the timeSinceL1L2Configuration IE.

In some embodiments, the wireless device 130 may be further configured to one or more of the following.

The wireless device 130 may be configured to perform the storing/logging/recording of Action 304, e.g. by means of a storing unit 502 within the wireless device 130, configured to, store any of the one or more indications responsive to the declared failure. The one or more indications configured to be sent may be the one or more indications configured to be stored.

The wireless device 130 may be configured to perform the receiving of Action 301, e.g. by means of a receiving unit 503 within the wireless device 130, configured to receive the previous indication.

The wireless device 130 may be configured to perform the performing of Action 302, e.g. by means of a performing unit 504, within the wireless device 130, configured to perform, responsive to the previous indication configured to be received, the mobility procedure from the first network node 111 to the second network node 112.

The wireless device 130 may be configured to perform the declaring of Action 303, e.g. by means of a declaring unit 505 within the wireless device 130, configured to declare the failure in the mobility procedure.

Other units 506 may be comprised in the wireless device 130.

The embodiments herein in the wireless device 130 may be implemented through one or more processors, such as a processor 507 in the wireless device 130 depicted in FIG. 5a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 508 comprising one or more memory units. The memory 508 is arranged to be used to store obtained information, store data, configurations, schedulings, and applications etc. to perform the methods herein when being executed in the wireless device 130.

In some embodiments, the wireless device 130 may receive information from, e.g., the first network node 111, the second network node 112, the third network node 113 and/or another network node or node, through a receiving port 509. In some embodiments, the receiving port 509 may be, for example, connected to one or more antennas in wireless device 130. In other embodiments, the wireless device 130 may receive information from another structure in the wireless communications network 100 through the receiving port 509. Since the receiving port 509 may be in communication with the processor 507, the receiving port 509 may then send the received information to the processor 507. The receiving port 509 may also be configured to receive other information.

The processor 507 in the wireless device 130 may be further configured to transmit or send information to e.g., the first network node 111, the second network node 112, the third network node 113, another network node or node, or another structure in the wireless communications network 100, through a sending port 510, which may be in communication with the processor 507, and the memory 508.

Those skilled in the art will also appreciate that the different units 501-506 described above may refer to a combination of analog and digital modules, and/or one or more processors configured with software and/or firmware, e.g., stored in memory, that, when executed by the one or more processors such as the processor 507, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 501-506 described above may be implemented as one or more applications running on one or more processors such as the processor 507.

Thus, the methods according to the embodiments described herein for the wireless device 130 may be respectively implemented by means of a computer program 511 product, comprising instructions, i.e., software code portions, which, when executed on at least one processor 507, cause the at least one processor 507 to carry out the actions described herein, as performed by the wireless device 130. The computer program 511 product may be stored on a computer-readable storage medium 512. The computer-readable storage medium 512, having stored thereon the computer program 511, may comprise instructions which, when executed on at least one processor 507, cause the at least one processor 507 to carry out the actions described herein, as performed by the wireless device 130. In some embodiments, the computer-readable storage medium 512 may be a non-transitory computer-readable storage medium, such as a CD ROM disc, or a memory stick. In other embodiments, the computer program 511 product may be stored on a carrier containing the computer program 511 just described, wherein the carrier is one of an electronic signal, optical signal, radio signal, or the computer-readable storage medium 512, as described above.

The wireless device 130 may comprise a communication interface configured to facilitate communications between the wireless device 130 and other nodes or devices, e.g., the first network node 111, the second network node 112, the third network node 113, another network node or node, or another structure in the wireless communications network 100. The interface may, for example, include a transceiver configured to transmit and receive radio signals over an air interface in accordance with a suitable standard.

In other embodiments, the wireless device 130 may comprise the following arrangement depicted in FIG. 5b. The wireless device 130 may comprise a processing circuitry 507, e.g., one or more processors such as the processor 507, in the wireless device 130 and the memory 508. The wireless device 130 may also comprise a radio circuitry 513, which may comprise e.g., the receiving port 509 and the sending port 510. The processing circuitry 513 may be configured to, or operable to, perform the method actions according to FIG. 3, in a similar manner as that described in relation to FIG. 5a. The radio circuitry 513 may be configured to set up and maintain at least a wireless connection with the first network node 111, the second network node 112, the third network node 113, another network node or node, or another structure in the wireless communications network 100. Circuitry may be understood herein as a hardware component.

Hence, embodiments herein also relate to the wireless device 130 comprising the processing circuitry 507 and the memory 508, said memory 508 containing instructions executable by said processing circuitry 507, whereby the wireless device 130 is operative to perform the actions described herein in relation to the wireless device 130, e.g., in FIG. 3.

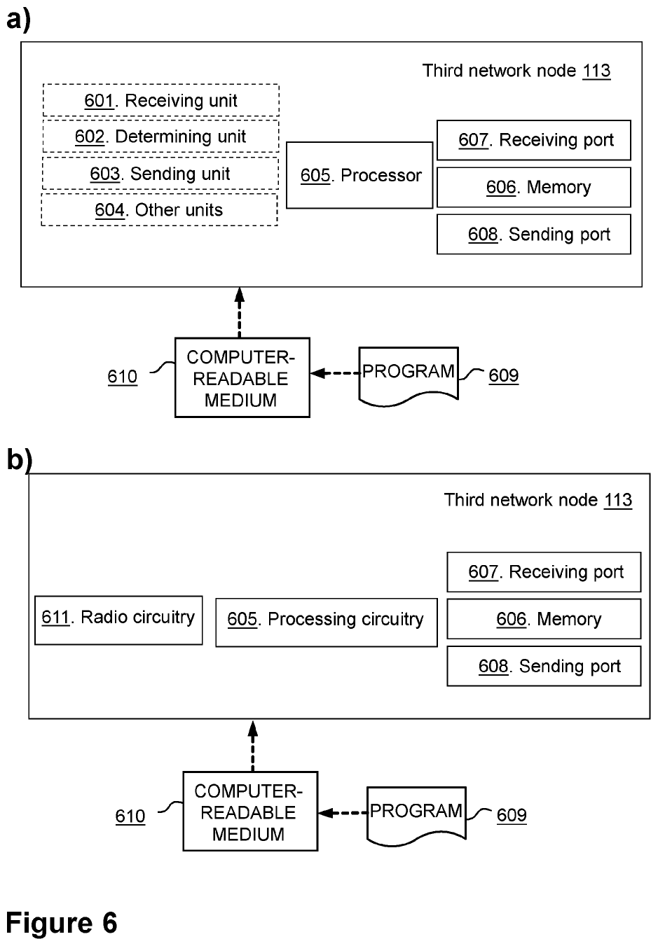

The third network node 113 may comprise an arrangement as shown in FIG. 6. FIG. 6 depicts two different examples in panels a) and b), respectively, of the arrangement that the third network node 113 may comprise to perform the method actions described above in relation to FIG. 4. In some embodiments, the third network node 113 may comprise the following arrangement depicted in FIG. 6a. The third network node 113 may be understood to be for handling the failure in the mobility procedure by the wireless device 130 from the first network node 111 to the second network node 112. The third network node 113 may be configured to operate in the wireless communications network 100.

In some embodiments, the wireless communications network 100 may be configured to support New Radio (NR).

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the failure may be configured to be, e.g., a radio link failure.

In FIG. 6, optional units are indicated with dashed boxes.

The third network node 113 may be configured to perform the receiving of Action 401, e.g., by means of a receiving unit 601 within the third network node 113, configured to receive, from the wireless device 130, the one or more indications configured to indicate the failed mobility procedure. The one or more indications may be configured to comprise at least the first indication configured to indicate whether the previous indication that indicated to the wireless device 130 to perform the last completed mobility procedure was received by the wireless device 130 via an L1/L2 operation or via an L3 operation.

In some embodiments, the one or more indications may be configured to further comprise at least one of: a) the second indication configured to indicate the source cell 121 in which the previous indication to perform the last completed mobility procedure was received, b) the third indication configured to indicate the time elapsed between the first time of execution of the last completed mobility procedure and the second time when the failure in the last completed mobility procedure was declared, c) the fourth indication configured to indicate whether the target cell 122 in which the last completed mobility procedure was executed was a) the SCell, b) the PSCell, or c) the non-serving candidate cell, while connected to the source Pcell d) the fourth indication, further configured to indicate the target cell 122 in which the last completed mobility procedure was executed was an SCell associated to an MCG, or an SCell associated to an SCG, e) the fifth indication configured to indicate whether the wireless device 130 was configured for L1/L2 inter-cell mobility procedure while connected to the target cell 122 at the second time when the failure in the last completed mobility procedure was declared, f) the sixth indication configured to indicate the third time elapsed between the storage of information indicating the last completed mobility procedure and the first time of execution of the last completed mobility procedure, or the second time when the failure, in the mobility procedure was declared, and g) the seventh indication configured to indicate whether the last completed mobility procedure was performed based on the conditional configuration or not.

In some embodiments, at least one of the following may apply: a) the one or more indications may be configured to be sent in the report, b) the one or more indications may be configured to be sent in the UEInformationResponse message, c) the failure may be configured to be the radio link failure, d) the mobility procedure may be configured to be the L1/L2 inter-cell mobility procedure, e) the first indication may be configured to be indicated by the lastHO-Type IE set to I1-I2Mobility procedure, f) the first indication may be configured to comprise the lastHO-Type IE set to I1-I2Mobility, g) with the proviso the previous indication was received via L1, the first indication may be configured to be indicated by the I1-I2Trigger set to I1 Trigger, h) with the proviso the previous indication was received via L2, the first indication may be configured to be indicated by the I1-I2Trigger IE set to I2Trigger, i) the second indication may be configured to be indicated by the previousL1L2Cell IE, j) the second indication may be configured to indicate, for the source cell 121, at least one of: the physical cell identifier, the operating frequency and the global cell identifier, k) the third indication may be configured to be indicated by the timeSinceL1L2mobility IE, l) the fourth indication may be configured to be indicated by the previousCellType IE, m) the fifth indication may be configured to be indicated by the targetL1L2Configured IE and j) the sixth indication may be configured to be indicated by the timeSinceL1L2Configuration IE.

In some embodiments, the network node 113 may be further configured to according to the following two configurations.

The third network node 113 may be configured to perform the determining of Action 402, e.g., by means of a determining unit 602 within the third network node 113, configured to, determine, based on the one or more indications configured to be received, the type of operation that triggered the last completed mobility procedure.

The third network node 113 may be configured to perform the sending of Action 405, e.g. by means of a sending unit 603 within the third network node 113, configured to send, based on the result of the determination, the further indication of the failed mobility procedure to the entity managing the operation, out of the L1/L2 operation and the L3 operation, that triggered the last completed mobility procedure.

In some embodiments, at least one of the following may apply: a) with the proviso that the last completed mobility procedure was triggered by the L1/L2 operation, the entity may be configured to be the distributed unit comprised in the third network node 113, and b) with the proviso that the last completed mobility procedure was triggered by the L3 operation, the entity may be configured to be the central unit comprised in the third network node 113. In some embodiments, the network node 113 may be further configured to perform at one or more additional determinations of the following.

The third network node 113 may be configured to perform the determining of Action 403, e.g. by means of the determining unit 602 within the third network node 113, configured to determine the type of cell in which the failure occurred.

The third network node 113 may be configured to perform the determining of Action 404, e.g., by means of the determining unit 602 within the third network node 113, configured to, determine how long the wireless device 130 had stored the configuration for the last completed mobility procedure associated to a candidate cell.

In some embodiments, the sending of the further indication may be further configured to comprise the one or more additional indications configured to indicate the result of the one or more additional determinations.

Other units 604 may be comprised in the third network node 113.

The embodiments herein in the third network node 113 may be implemented through one or more processors, such as a processor 605 in the third network node 113 depicted in FIG. 6a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third network node 113. One such carrier may be in the form of a CD ROM disc. It is however feasible with other data carriers such as a memory stick. The computer program code may furthermore be provided as pure program code on a server and downloaded to the third network node 113.

The third network node 113 may further comprise a memory 606 comprising one or more memory units. The memory 606 is arranged to be used to store obtained information, store data, configurations, schedulings, and applications etc. to perform the methods herein when being executed in the third network node 113.

In some embodiments, the third network node 113 may receive information from, e.g., the wireless device 130, the first network node 111, the second network node 112, and/or another network node or node, through a receiving port 607. In some embodiments, the receiving port 607 may be, for example, connected to one or more antennas in third network node 113. In other embodiments, the third network node 113 may receive information from another structure in the wireless communications network 100 through the receiving port 607. Since the receiving port 607 may be in communication with the processor 605, the receiving port 607 may then send the received information to the processor 605. The receiving port 607 may also be configured to receive other information.

The processor 605 in the third network node 113 may be further configured to transmit or send information to e.g., the wireless device 130, the first network node 111, the second network node 112, another network node or node, and/or another structure in the wireless communications network 100, through a sending port 608, which may be in communication with the processor 605, and the memory 606.

Those skilled in the art will also appreciate that the different units 601-604 described above may refer to a combination of analog and digital modules, and/or one or more processors configured with software and/or firmware, e.g., stored in memory, that, when executed by the one or more processors such as the processor 605, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 601-604 described above may be implemented as one or more applications running on one or more processors such as the processor 605.

Thus, the methods according to the embodiments described herein for the third network node 113 may be respectively implemented by means of a computer program 609 product, comprising instructions, i.e., software code portions, which, when executed on at least one processor 605, cause the at least one processor 605 to carry out the actions described herein, as performed by the third network node 113. The computer program 609 product may be stored on a computer-readable storage medium 610. The computer-readable storage medium 610, having stored thereon the computer program 609, may comprise instructions which, when executed on at least one processor 605, cause the at least one processor 605 to carry out the actions described herein, as performed by the third network node 113. In some embodiments, the computer-readable storage medium 610 may be a non-transitory computer-readable storage medium, such as a CD ROM disc, or a memory stick. In other embodiments, the computer program 609 product may be stored on a carrier containing the computer program 609 just described, wherein the carrier is one of an electronic signal, optical signal, radio signal, or the computer-readable storage medium 610, as described above.

The third network node 113 may comprise a communication interface configured to facilitate communications between the third network node 113 and other nodes or devices, e.g., the wireless device 130, the first network node 111, the second network node 112, another network node or node, and/or another structure in the wireless communications network 100. The interface may, for example, include a transceiver configured to transmit and receive radio signals over an air interface in accordance with a suitable standard.

In other embodiments, the third network node 113 may comprise the following arrangement depicted in FIG. 6b. The third network node 113 may comprise a processing circuitry 605, e.g., one or more processors such as the processor 605, in the third network node 113 and the memory 606. The third network node 113 may also comprise a radio circuitry 611, which may comprise e.g., the receiving port 607 and the sending port 608. The processing circuitry 605 may be configured to, or operable to, perform the method actions according to FIG. 4, in a similar manner as that described in relation to FIG. 6a. The radio circuitry 611 may be configured to set up and maintain at least a wireless connection with the wireless device 130, the first network node 111, the second network node 112, another network node or node, and/or another structure in the wireless communications network 100. Circuitry may be understood herein as a hardware component.

Hence, embodiments herein also relate to the third network node 113 comprising the processing circuitry 605 and the memory 606, said memory 606 containing instructions executable by said processing circuitry 605, whereby the third network node 113 is operative to perform the actions described herein in relation to the third network node 113, e.g., FIG. 4.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

In a non-limiting example, L1/L2 operation may be understood as an operation involving L1 and/or L2 signalling.

In a non-limiting example, L3 operation may be understood as an operation involving L3 signalling.

In a non-limiting example, L1 signalling may be understood as any operation with interaction/signalling between the Physical (PHY) layer of a radio network node, e.g., a gNB, and the PHY layer of a device, e.g., UE. In a non-limiting example, L2 signalling may be understood as any operation with interaction/signalling between at the Layer 2, e.g., MAC layer or RLC layer, between a RAN node, e.g., a gNB-DU, and a device, e.g., a UE.

In a non-limiting example, L3 signalling may be understood as any signal at the Layer 3 level, e.g., RRC layer, between a device, e.g., UE RRC layer, and a RAN node, e.g., gNB-CU).

In a non-limiting example, a mobility procedure may be understood as a procedure involving a change of a serving cell such as a PCell, PSCell, or secondary cell SCell.

In a non-limiting example, a mobility procedure may be understood as a procedure involving a change of a serving cell such as a PCell, PSCell, or secondary cell SCell.

### Examples Related to Embodiments Herein

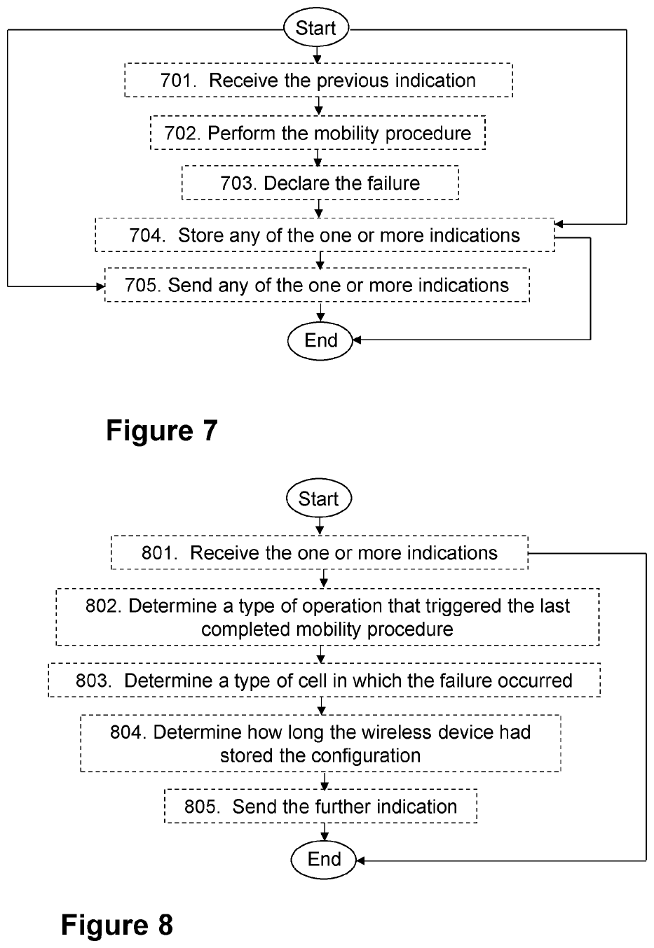

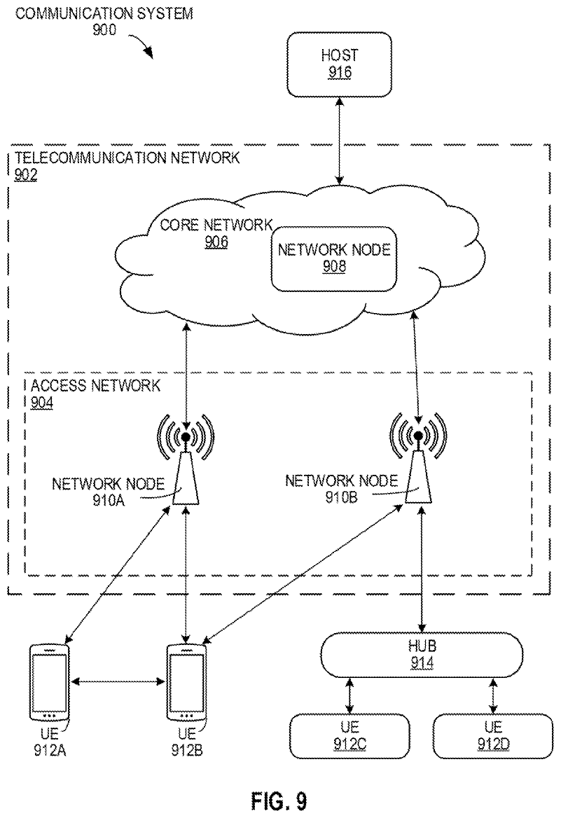

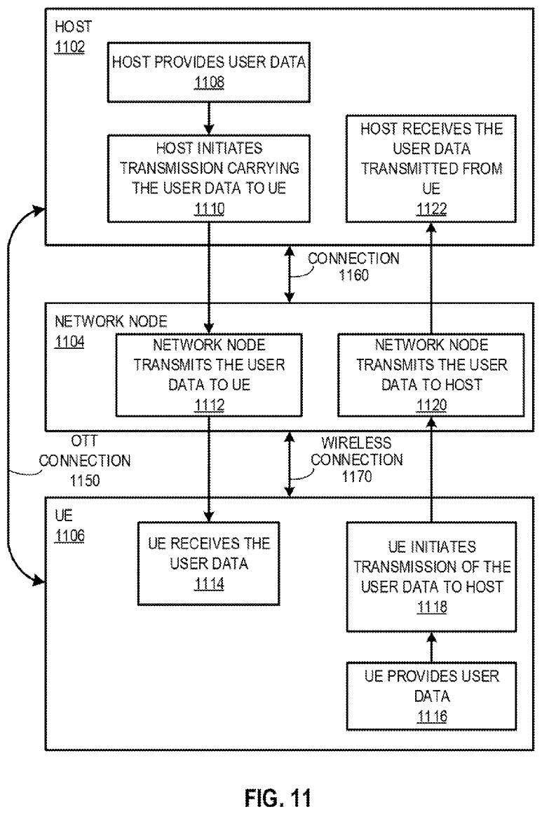

The wireless device 130 embodiments relate to FIG. 7, FIG. 5, FIG. 9 and FIG. 11.

A method, performed by a wireless device, such as the wireless device 130 is described herein. The method may be understood to be for handling a failure in a mobility procedure by the wireless device 130, e.g., from the first network node 111 to the second network node 112. The wireless device 130 may be operating in a wireless communications network, such as the wireless communications network 100.

The failure may be, e.g., a radio link failure.

A mobility procedure may also be referred to herein simply as mobility.

In some particular embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 7. In FIG. 7, optional actions in some embodiments may be represented with dashed lines. In some embodiments, the actions may be performed in a different order than that depicted FIG. 7.
Sending 705 one or more indications. The wireless device 130 may be configured to perform the sending of this Action 705, e.g. by means of a sending unit 501 within the wireless device, configured to perform this action.

The sending in this Action 705 may to the third network node 113, which may also be referred to simply as the network node 113. The third network node 113 may be serving the wireless device 130 in the wireless communications network 100.

The sending in this Action 704 may be performed, e.g., via the first link 141.

The one or more indications may indicate the failed mobility procedure. That is, the mobility procedure for which the failure may be handled.

The one or more indications may comprise at least a first indication.

The first indication may indicate whether a previous indication that indicated to the wireless device 130 to perform a last completed mobility procedure was received by the wireless device 130 via a Layer 1/Layer 2 (L1/L2) operation or via a Layer 7 (L3) operation.

The previous indication may have been received, e.g., from the first network node 111, from the second network node 112, or from another network node operating in the wireless communications network 100.

In some examples, the one or more indications may further comprise at least one of:
a second indication; the second indication may indicate a source cell 121 in which the previous indication to perform the last completed mobility procedure, e.g., L1/L2 inter-cell mobility procedure, was received,
a third indication; the third indication may indicate a time elapsed between a first time of execution of the last completed mobility procedure, e.g., L1/L2 inter-cell mobility procedure, and a second time when the failure, e.g., radio link failure, in the last completed mobility procedure was declared,
a fourth indication; the fourth indication may indicate whether a target cell 122 in which the last completed mobility procedure, e.g., L1/L2 inter-cell mobility procedure, was executed was a) a secondary cell (SCell), b) a primary secondary cell (PSCell), or c) a non-serving candidate cell, while connected to a source primary cell (Pcell),
the fourth indication, e.g., further indicating the target cell 122 in which the last completed mobility procedure, e.g., L1/L2 inter-cell mobility procedure, was executed was an SCell associated to a Master Cell Group (MCG), or an SCell associated to a Secondary Cell Group (SCG),
a fifth indication; the fifth indication may indicate whether the wireless device 130 was configured for L1/L2 inter-cell mobility procedure while connected to the target cell 122, e.g., PCell, at the second time when the failure, e.g., radio link failure, in the last completed mobility procedure was declared,
a sixth indication; the sixth indication may indicate a third time elapsed between a storage of information indicating the last completed mobility procedure, e.g., L1/L2 inter-cell mobility procedure, and the first time of execution of the last completed mobility procedure, e.g., L1/L2 inter-cell mobility procedure, or the second time when the failure, e.g., radio link failure, in the mobility procedure was declared, and
a seventh indication; the seventh indication may indicate whether the last completed mobility procedure, e.g., L1/L2 inter-cell mobility procedure, was performed based on a conditional configuration or not.

In some examples, at least one of the following may apply:
the one or more indications may be sent in a report,
the one or more indications may be sent in a UEInformationResponse message,
the failure may be a radio link failure,
the mobility procedure may be an L1/L2 inter-cell mobility procedure,
the first indication may be indicated by a lastHO-Type information element (IE), e.g., set to I1-I2Mobility procedure,
the first indication may comprise a lastHO-Type IE, e.g., set to I1-I2Mobility,
with the proviso that the previous indication was received via L1, the first indication may be indicated by an I1-I2Trigger set to 11Trigger,
with the proviso that the previous indication was received via L2, the first indication may be indicated by an I1-I2Trigger IE set to I2Trigger,
the second indication may be indicated by a previousL1L2Cell IE,
the second indication may indicate, for the source cell 121, at least one of: a physical cell identifier, an operating frequency and a global cell identifier,
the third indication may be indicated by a timeSinceL1L2mobility IE,
the fourth indication may be indicated by a previousCellType IE,
the fifth indication may be indicated by a targetL1L2Configured IE,
the sixth indication may be indicated by a timeSinceL1L2Configuration IE.

In some embodiments, the method may comprise, additionally, or alternatively, the following action:
Storing/Logging/Recording 704 any of the one or more indications. The wireless device 130 may be configured to perform the storing/logging/recording in this Action 704, e.g. by means of a storing unit 502 within the wireless device 130, configured to perform this action.

The storing/logging/recording in this Action 704 may be responsive to the declared failure.

The sent one or more indications may be the stored one or more indications, e.g., a subset selected from the stored one or more indications.

In some embodiments, the method may comprise one or more of the following actions:
Receiving 701 the previous indication. The wireless device 130 may be configured to perform the receiving in this Action 701, e.g. by means of a receiving unit 503 within the wireless device 130, configured to perform this action.

The receiving in this Action 705 may be, e.g., from the first network node 111, from the second network node 112, or from another network node operating in the wireless communications network 100.
Performing 702 the mobility procedure. The wireless device 130 may be configured to perform the performing in this Action 702, e.g. by means of a performing unit 504, within the wireless device 130, configured to perform this action.

The mobility procedure may be, e.g., L1/L2 inter-cell mobility procedure.

The mobility procedure may be from the first network node 111 to the second network node 112, e.g., from the source cell 121 to the target cell 122.

The performing in this Action 702 may be, e.g., responsive to the received previous indication.
Declaring 703 the failure in the mobility procedure. The wireless device 130 may be configured to perform the declaring of this Action 703, e.g. by means of a declaring unit 505 within the wireless device 130, configured to perform this action.

The failure may be, e.g., radio link failure.

Other units 506 may be comprised in the wireless device 130.

The wireless device 130 may also be configured to communicate user data with a host application unit in a host 916, 1000, 1102, e.g., via an OTT connection such as OTT connection 1150.

In FIG. 5, optional units are indicated with dashed boxes.

The wireless device 130 may comprise an interface unit to facilitate communications between the wireless device 130 and other nodes or devices, e.g., the third network node 113, the host 916, 1000, 1102, or any of the other nodes. In some particular examples, the interface may, for example, include a transceiver configured to transmit and receive radio signals over an air interface in accordance with a suitable standard.

The third network node 113 embodiments relate to FIG. 8, FIG. 6, FIG. 9 and FIG. 11.

A method, performed by a network node, such as the third network node 113 is described herein. The method may be understood to be for handling a failure in a mobility procedure by the wireless device 130, e.g., from the first network node 111 to the second network node 112. The third network node 113 may be operating in a wireless communications network, such as the wireless communications network 100.

In some embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the third network node 113 is depicted in FIG. 8. In FIG. 8, optional actions in some embodiments may be represented with dashed lines. In some embodiments, the actions may be performed in a different order than that depicted FIG. 8.

The detailed description of some of the following corresponds to the same references provided above, in relation to the actions described for the wireless device 130 and will thus not be repeated here to simplify the description. For example, the failure may be, e.g., a radio link failure.
Receiving 801 the one or more indications, e.g., the subset of the one or more indications. The third network node 113 may be configured to perform the receiving in this Action 801, e.g. by means of a receiving unit 601 within the third network node 113, configured to perform this action.

The receiving in this Action 801 may be from the wireless device 130.

The receiving in this Action 801 may be performed, e.g., via the first link 141. The one or more indications may indicate the failed mobility procedure. That is, the mobility procedure for which the failure may be handled.

The one or more indications may comprise at least the first indication.

The first indication may indicate whether the previous indication that indicated to the wireless device 130 to perform the last completed mobility procedure was received by the wireless device 130 via an L1/L2 operation or via an L3 operation.

The previous indication may have been received, e.g., from the first network node 111, from the second network node 112, or from another network node operating in the wireless communications network 100.

In some examples, the one or more indications may further comprise at least one of:
the second indication; the second indication may indicate the source cell 121 in which the previous indication to perform the last completed mobility procedure, e.g., L1/L2 inter-cell mobility procedure, was received,
the third indication; the third indication may indicate the time elapsed between the first time of execution of the last completed mobility procedure, e.g., L1/L2 inter-cell mobility procedure, and the second time when the failure, e.g., radio link failure, in the last completed mobility procedure was declared,
the fourth indication; the fourth indication may indicate whether the target cell 122 in which the last completed mobility procedure, e.g., L1/L2 inter-cell mobility procedure, was executed was a) a secondary cell (SCell), b) a primary secondary cell (PSCell), or c) a non-serving candidate cell, while connected to the source primary cell (Pcell),
the fourth indication, e.g., further indicating the target cell 122 in which the last completed mobility procedure, e.g., L1/L2 inter-cell mobility procedure, was executed was an SCell associated to a Master Cell Group (MCG), or an SCell associated to a Secondary Cell Group (SCG),
the fifth indication; the fifth indication may indicate whether the wireless device 130 was configured for L1/L2 inter-cell mobility procedure while connected to the target cell 122, e.g., PCell, at the second time when the failure, e.g., radio link failure, in the last completed mobility procedure was declared,
the sixth indication; the sixth indication may indicate the third time elapsed between the storage of information indicating the last completed mobility procedure, e.g., L1/L2 inter-cell mobility procedure, and the first time of execution of the last completed mobility procedure, e.g., L1/L2 inter-cell mobility procedure, or the second time when the failure, e.g., radio link failure, in the mobility procedure was declared, and
the seventh indication; the seventh indication may indicate whether the last completed mobility procedure, e.g., L1/L2 inter-cell mobility procedure, was performed based on a conditional configuration or not.

In some examples, at least one of the following may apply:
the one or more indications may be sent in the report,
the one or more indications may be sent in the UEInformationResponse message,
the failure may be a radio link failure,
the mobility procedure may be an L1/L2 inter-cell mobility procedure,
the first indication may be indicated by the lastHO-Type information element (IE), e.g., set to I1-I2Mobility,
the first indication may comprise the lastHO-Type IE, e.g., set to I1-I2Mobility procedure,
with the proviso that the previous indication was received via L1, the first indication may be indicated by the I1-I2Trigger set to 11Trigger,
with the proviso that the previous indication was received via L2, the first indication may be indicated by the I1-I2Trigger IE set to I2Trigger,
the second indication may be indicated by the previousL1L2Cell IE,
the second indication may indicate, for the source cell 121, at least one of: the physical cell identifier, the operating frequency and the global cell identifier,
the third indication may be indicated by the timeSinceL1L2mobility IE,
the fourth indication may be indicated by the previousCellType IE,
the fifth indication may be indicated by the targetL1L2Configured IE,
the sixth indication may be indicated by the timeSinceL1L2Configuration IE.

In some embodiments, the method may further comprise one or more of the following actions:
Determining 802 a type of operation that triggered the last completed mobility procedure, e.g., whether the last completed mobility procedure was triggered by the L1/L2 operation or by the L3 operation. The third network node 113 may be configured to perform the determining in this Action 802, e.g. by means of a determining unit 602 within the third network node 113, configured to perform this action.

Determining may comprise calculating, checking, deriving, etc.

The determining in this Action 802 may be based on the received one or more indications, e.g., the received subset of the one or more operations.

Sending 805 a further indication. The third network node 113 may be configured to perform the sending in this Action 805, e.g. by means of a sending unit 603 within the third network node 113, configured to perform this action.

The sending in this Action 803 may be to e.g., another network node, e.g., another radio network node or a core network node, operating in the wireless communications network 100.

The sending in this Action 805 may be, e.g., based on a result of the determination performed in Action 802.

The further indication may be of the failed mobility to an entity managing the operation, out of the L1/L2 operation and the L3 operation, that may have triggered last completed mobility.

In some embodiments, at least one of the following may apply:
with the proviso that the last completed mobility was triggered by the L1/L2 operation, the entity may be a distributed unit, DU, comprised in the third network node 113, and
with the proviso that the last completed mobility was triggered by the L3 operation, the entity may be a central unit, CU, comprised in the third network node 113.

In some embodiments, the method may further comprise one or more additional determinations of:
Determining 803 a type of cell in which the failure occurred, e.g., whether a cell in which the failure occurred was a serving cell or a non-serving cell while connected to the source cell 121. The third network node 113 may be configured to perform the determining in this Action 803, e.g. by means of the determining unit 602 within the third network node 113, configured to perform this action.
Determining 804 how long the wireless device 130 had stored a configuration for last completed mobility procedure, e.g., L1/L2 inter-cell mobility, associated to a candidate cell. The third network node 113 may be configured to perform the determining in this Action 804, e.g. by means of the determining unit 602 within the third network node 113, configured to perform this action.

In some examples, the sending in Action 805 of the further indication may further comprise one or more additional indications indicating a result of the one or more additional determinations 803, 804.

Other units 604 may be comprised in the third network node 113.

The third network node 113 may also be configured to communicate user data with a host application unit in a host 916, 1000, 1102, e.g., via a connection 1160.

In FIG. 6, optional units are indicated with dashed boxes.

The third network node 113 may comprise an interface unit to facilitate communications between the third network node 113 and other nodes or devices, e.g., the wireless device 130, the first network node 111, the second network node 112, the another node, the host 916, 1000, 1102, or any of the other nodes. In some particular examples, the interface may, for example, include a transceiver configured to transmit and receive radio signals over an air interface in accordance with a suitable standard.

The third network node 113 may comprise an arrangement as shown in FIG. 6.

Selected examples related to embodiments herein

EXAMPLE 1. A method performed by a wireless device (130), the method being for handling a failure in a mobility procedure by the wireless device (130) from a first network node (111) to a second network node (112), the wireless device (130) operating in a wireless communications network (100), and the method comprising:
sending (705), to a (third) network node (113) serving the wireless device (130) in the wireless communications network (100), e.g., any of/a subset of, one or more indications indicating the failed mobility procedure, the one or more indications comprising at least a first indication indicating whether a previous indication that indicated to the wireless device (130) to perform a last completed mobility procedure was received by the wireless device (130) via a Layer 1/Layer 2, L1/L2, operation or via a Layer 7, L3, operation.

EXAMPLE 2. The method according to example 1, wherein the one or more indications further comprise at least one of:
a second indication indicating a source cell (121) in which the previous indication to perform the last completed mobility procedure, e.g., L1/L2 inter-cell mobility procedure, was received,
a third indication indicating a time elapsed between a first time of execution of the last completed mobility procedure, e.g., L1/L2 inter-cell mobility procedure, and a second time when the failure, e.g., radio link failure, in the last completed mobility procedure was declared.
a fourth indication indicating whether a target cell (122) in which the last completed mobility procedure, e.g., L1/L2 inter-cell mobility procedure, was executed was a) a secondary cell, SCell, b) a primary secondary cell, PSCell, or c) a non-serving candidate cell, while connected to a source primary cell, Pcell,
the fourth indication, further indicating the target cell (122) in which the last completed mobility procedure, e.g., L1/L2 inter-cell mobility procedure, was executed was an SCell associated to a Master Cell Group, MCG, or an SCell associated to a Secondary Cell Group, SCG,
a fifth indication indicating whether the wireless device (130) was configured for L1/L2 inter-cell mobility procedure while connected to the target cell (122), e.g., PCell, at the second time when the failure, e.g., radio link failure, in the last completed mobility procedure was declared,
a sixth indication indicating a third time elapsed between a storage of information indicating the last completed mobility procedure, e.g., L1/L2 inter-cell mobility procedure, and the first time of execution of the last completed mobility procedure, e.g., L1/L2 inter-cell mobility procedure, or the second time when the failure, e.g., radio link failure, in the mobility procedure was declared, and
a seventh indication indicating whether the last completed mobility procedure, e.g., L1/L2 inter-cell mobility procedure, was performed based on a conditional configuration or not.

EXAMPLE 3. The method according to example 2, wherein at least one of:
the one or more indications are sent in a report,
the one or more indications are sent in a UEInformationResponse message,
the failure is a radio link failure, and
the mobility procedure is an L1/L2 inter-cell mobility procedure,
the first indication is indicated by a lastHO-Type information element, IE, set to I1-I2Mobility,
the first indication comprises a lastHO-Type IE set to I1-I2Mobility,
with the proviso the previous indication was received via L1, the first indication is indicated by an I1-I2Trigger set to I1Trigger,
with the proviso the previous indication was received via L2, the first indication is indicated by an I1-I2Trigger IE set to I2Trigger,
the second indication is indicated by a previousL1L2Cell IE,
the second indication indicates, for the source cell (121), at least one of: a physical cell identifier, an operating frequency and a global cell identifier,
the third indication is indicated by a timeSinceL1L2mobility IE,
the fourth indication is indicated by a previousCellType IE,
the fifth indication is indicated by a targetL1L2Configured IE,
the sixth indication is indicated by a timeSinceL1L2Configuration IE.

EXAMPLE 4. The method according to any of examples 1-3, further comprising one or more of:
receiving (701) the previous indication,
performing (702), responsive to the received previous indication, the mobility procedure, e.g., L1/L2 inter-cell mobility procedure, from the first network node (111) to the second network node (112),
declaring (703) the failure, e.g., radio link failure, in the mobility procedure, and storing (704) any of the one or more indications responsive to the declared-failure, and wherein the sent one or more indications are the stored one or more indications.

EXAMPLE 5. A method performed by a (third) network node (113), the method being for handling a failure in a mobility procedure by the wireless device (130) from a first network node (111) to a second network node (112), the network node (110) operating in a wireless communications network (100), and the method comprising:
receiving (801), from the wireless device (130), e.g., any of/a subset of, one or more indications indicating the failed mobility procedure, the one or more indications comprising at least a first indication indicating whether a previous indication that indicated to the wireless device (130) to perform a last completed mobility procedure was received by the wireless device (130) via a Layer 1/Layer 2, L1/L2, operation or via a Layer 7, L3, operation.

EXAMPLE 6. The method according to example 5, wherein the one or more indications further comprise at least one of:
a second indication indicating a source cell (121) in which the previous indication to perform the last completed mobility procedure, e.g., L1/L2 inter-cell mobility procedure, was received,
a third indication indicating a time elapsed between a first time of execution of the last completed mobility procedure, e.g., L1/L2 inter-cell mobility procedure, and a second time when the failure, e.g., radio link failure, in the last completed mobility procedure was declared.
a fourth indication indicating whether a target cell (122) in which the last completed mobility procedure, e.g., L1/L2 inter-cell mobility procedure, was executed was a) a secondary cell, SCell, b) a primary secondary cell, PSCell, or c) a non-serving candidate cell, while connected to a source primary cell, Pcell,
the fourth indication, further indicating the target cell (122) in which the last completed mobility procedure, e.g., L1/L2 inter-cell mobility procedure, was executed was an SCell associated to a Master Cell Group, MCG, or an SCell associated to a Secondary Cell Group, SCG,
a fifth indication indicating whether the wireless device (130) was configured for L1/L2 inter-cell mobility procedure while connected to the target cell (122), e.g., PCell, at the second time when the failure, e.g., radio link failure, in the last completed mobility procedure was declared,
a sixth indication indicating a third time elapsed between a storage of information indicating the last completed mobility procedure, e.g., L1/L2 inter-cell mobility procedure, and the first time of execution of the last completed mobility procedure, e.g., L1/L2 inter-cell mobility procedure, or the second time when the failure, e.g., radio link failure, in the mobility procedure was declared, and
a seventh indication indicating whether the last completed mobility procedure, e.g., L1/L2 inter-cell mobility procedure, was performed based on a conditional configuration or not.

EXAMPLE 7. The method according to example 6, wherein at least one of: the one or more indications are sent in a report,
the one or more indications are sent in a UEInformationResponse message,
the failure is a radio link failure, and
the mobility procedure is an L1/L2 inter-cell mobility procedure,
the first indication is indicated by a lastHO-Type information element, IE, set to I1-I2Mobility procedure,
the first indication comprises a lastHO-Type IE set to I1-I2Mobility,
with the proviso the previous indication was received via L1, the first indication is indicated by an I1-I2Trigger set to 11 Trigger,
with the proviso the previous indication was received via L2, the first indication is indicated by an I1-I2Trigger IE set to I2Trigger,
the second indication is indicated by a previousL1L2Cell IE,
the second indication indicates, for the source cell (121), at least one of: a physical cell identifier, an operating frequency and a global cell identifier,
the third indication is indicated by a timeSinceL1L2mobility IE,
the fourth indication is indicated by a previousCellType IE,
the fifth indication is indicated by a targetL1L2Configured IE,
the sixth indication is indicated by a timeSinceL1L2Configuration IE.

EXAMPLE 8. The method according to any of examples 5-7, and wherein the method further comprises:
determining (802), based on the received one or more indications, a type of operation that triggered the last completed mobility procedure, e.g., whether the last completed mobility procedure was triggered by the L1/L2 operation or by the L3 operation, and
sending (805), based on a result of the determination, a further indication of the failed mobility procedure to an entity managing the operation, out of the L1/L2 operation and the L3 operation, that triggered last completed mobility procedure.

EXAMPLE 9. The method according to example 8, wherein at least one of:
with the proviso that the last completed mobility procedure was triggered by the L1/L2 operation, the entity is a distributed unit comprised in the (third) network node (113), and
with the proviso that the last completed mobility procedure was triggered by the L3 operation, the entity is a central unit comprised in the (third) network node (113).

EXAMPLE 10. The method according to example 6 or 7 and example 8 or 9, further comprising one or more additional determinations of:
determining (803) a type of cell in which the failure occurred, e.g., whether a cell in which the failure occurred was a serving cell or a non-serving cell while connected to the source cell (121), and
determining (804) how long the wireless device (130) had stored a configuration for last completed mobility procedure, e.g., L1/L2 inter-cell mobility procedure, associated to a candidate cell,
and wherein the sending (805) of the further indication further comprises one or more additional indications indicating a result of the one or more additional determinations.

### Further Extensions And Variations

FIG. 9 shows an example of a communication system 900 in accordance with some embodiments.

In the example, the communication system 900, such as the wireless communications network 100, includes a telecommunication network 902 that includes an access network 904, such as a radio access network (RAN), and a core network 906, which includes one or more core network nodes 908. The access network 904 includes one or more access network nodes, such as the third network node 113. For example, network nodes 910a and 910b, one or more of which may be generally referred to as network nodes 910, or any other similar 3rd Generation Partnership Project (3GPP) access node or non-3GPP access point. The communications system 900 comprises a plurality of wireless devices, such as the wireless device 130. In FIG. 9, the plurality of wireless devices comprises UEs 912a, 912b, 912c, and 912d, one or more of which may be generally referred to as UEs 912. The network nodes 910 facilitate direct or indirect connection of user equipment (UE), such as by connecting UEs 912a, 912b, 912c, and 912d to the core network 906 over one or more wireless connections. Any of the UEs 912a, 912b, 912c, and 912d are examples of the wireless device 130.

In relation to FIGS. 9, 10, and 11, which are described next, it may be understood that any UE is an example of the wireless device 130, and that any description provided for the UE 912 or for the UE 1106 equally applies to the wireless device 130. It may be also understood that any network node is an example of the third network node 113, and that any description provided for any network node 910 or for the network node 1104 equally applies to the third network node 113. It may further be understood that the communication system 900 is an example of the wireless communication network 100, and that any description provided for the communication system 900 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless device 130, exemplified in FIG. 9 as the UEs 912, may be any of a wide variety of communication devices, including wireless devices arranged, configured, and/or operable to communicate wirelessly with the third network node 113, exemplified in FIG. 9 as network nodes 910, and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes, e.g., core network node 908, that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, New Radio (NR) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs, e.g., UE 912c and/or 912d, and network nodes, e.g., network node 910b. In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

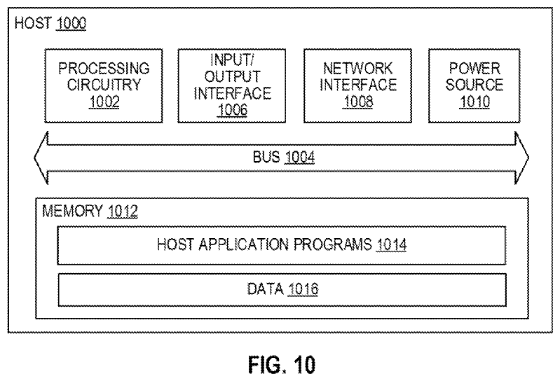

FIG. 10 is a block diagram of a host 1000, which may be an embodiment of the host 916 of FIG. 9, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 shows a communication diagram of a host 1102 communicating via a network node 1104 with a UE 1106 over a partially wireless connection in accordance with some embodiments. Example implementations, in accordance with various embodiments, of the UE, such as a UE 912a of Figure QQ, network node, such as network node 910a of FIG. 9, and host, such as host 916 of FIG. 9 and/or host 1000 of FIG. 10, discussed in the preceding paragraphs will now be described with reference to FIG. 11.

Like host 1000, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 906 of FIG. 9) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the data rate, latency, power consumption and thereby provide benefits such as reduced user waiting time, reduced overhead, and extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion, e.g., controlling traffic lights. As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors, not shown, may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

The wireless device 130 embodiments relate to FIG. 3, FIG. 5, FIG. 7, FIG. 9 and FIG. 11.

The wireless device 130 may also be configured to communicate user data with a host application unit in a host 916, 1000, 1102, e.g., via an OTT connection such as OTT connection 1150.

The wireless device 130 may comprise an interface unit to facilitate communications between the wireless device 130 and other nodes or devices, e.g., the third network node 113, the host 916, 1000, 1102, or any of the other nodes. In some particular examples, the interface may, for example, include a transceiver configured to transmit and receive radio signals over an air interface in accordance with a suitable standard.

The third network node 113 embodiments relate to FIG. 4, FIG. 6, FIG. 8, FIG. 9 and FIG. 11.

The third network node 113 may also be configured to communicate user data with a host application unit in a host 916, 1000, 1102, e.g., via a connection 1160.

The third network node 113 may comprise an interface unit to facilitate communications between the third network node 113 and other nodes or devices, e.g., the wireless device 130, the first network node 111, the second network node 112, the another node, the host 916, 1000, 1102, or any of the other nodes. In some particular examples, the interface may, for example, include a transceiver configured to transmit and receive radio signals over an air interface in accordance with a suitable standard.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the third network node 113.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the third network node 113.

4 The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the third network node 113.

7. The communication system of the previous embodiment, further comprising:
the network node; and/or
the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the third network node 113.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the third network node 113.

13. The method of the previous embodiment, further comprising at the network node, transmitting the received user data to the host.

14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.

15. The host of the previous embodiment, wherein the cellular network further includes a network node configured to communicate with the UE to transmit the user data to the UE from the host.

16. The host of the previous 2 embodiments, wherein:
the processing circuitry of the host is configured to execute a host application, thereby providing the user data; and
the host application is configured to interact with a client application executing on the UE, the client application being associated with the host application.

17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.

18. The method of the previous embodiment, further comprising:
at the host, executing a host application associated with a client application executing on the UE to receive the user data from the UE.

19. The method of the previous embodiment, further comprising:
at the host, transmitting input data to the client application executing on the UE, the input data being provided by executing the host application,
wherein the user data is provided by the client application in response to the input data from the host application.

20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.

21. The host of the previous embodiment, wherein the cellular network further includes a network node configured to communicate with the UE to transmit the user data from the UE to the host.

22. The host of the previous 2 embodiments, wherein:
the processing circuitry of the host is configured to execute a host application, thereby providing the user data; and
the host application is configured to interact with a client application executing on the UE, the client application being associated with the host application.

23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.

24. The method of the previous embodiment, further comprising:
at the host, executing a host application associated with a client application executing on the UE to receive the user data from the UE.

25. The method of the previous embodiments, further comprising:
at the host, transmitting input data to the client application executing on the UE, the input data being provided by executing the host application,
wherein the user data is provided by the client application in response to the input data from the host application.

### REFERENCES

1. RP-211586, 3GPP work item description: Further enhancements on MIMO for NR, Samsung, 3GPP TSG RAN Meeting #92e, Electronic Meeting, Jun. 14-18, 2021
2. RP-213565, 3GPP work item description: Further NR mobility enhancements, MediaTek, 3GPP TSG RAN Meeting #94e. Electronic Meeting. Dec. 6-17, 2021

1.-20. (canceled)

21. A method performed by a wireless device, for handling a failure in a mobility procedure by the wireless device from a first network node to a second network node, the wireless device operating in a wireless communications network, the method comprising:
sending, to a third network node serving the wireless device in the wireless communications network, one or more indications indicating the failed mobility procedure, the one or more indications comprising at least a first indication indicating whether a previous indication that indicated to the wireless device to perform a last completed mobility procedure was received by the wireless device via a Layer 1/Layer 2 (L1/L2) operation or via a Layer 3 (L3) operation.

22. The method according to claim 21, wherein the one or more indications further comprise at least one of:
a second indication indicating a source cell in which the previous indication to perform the last completed mobility procedure was received,
a third indication indicating a time elapsed between a first time of execution of the last completed mobility procedure and a second time when the failure in the last completed mobility procedure was declared,
a fourth indication indicating whether a target cell in which the last completed mobility procedure was executed was a) a secondary cell (SCell), b) a primary secondary cell (PSCell), or c) a non-serving candidate cell, while connected to a source primary cell (Pcell),
the fourth indication, further indicating the target cell in which the last completed mobility procedure was executed was an SCell associated to a Master Cell Group (MCG) or an SCell associated to a Secondary Cell Group (SCG),
a fifth indication indicating whether the wireless device was configured for L1/L2 inter-cell mobility procedure while connected to the target cell at the second time when the failure in the last completed mobility procedure was declared,
a sixth indication indicating a third time elapsed between a storage of information indicating the last completed mobility procedure and the first time of execution of the last completed mobility procedure or the second time when the failure in the mobility procedure was declared, and
a seventh indication indicating whether the last completed mobility procedure was performed based on a conditional configuration or not.

23. The method according to claim 22, wherein at least one of:
the one or more indications are sent in a report,
the one or more indications are sent in a UEInformationResponse message,
the failure is a radio link failure,
the mobility procedure is an L1/L2 inter-cell mobility procedure,
the first indication is indicated by a lastHO-Type information element (IE) set to I1-I2Mobility,
the first indication comprises a lastHO-Type IE set to I1-I2Mobility,
with the proviso the previous indication was received via L1, the first indication is indicated by an I1-I2Trigger set to I1Trigger,
with the proviso the previous indication was received via L2, the first indication is indicated by an I1-I2Trigger IE set to I2Trigger,
the second indication is indicated by a previousL1L2Cell IE,
the second indication indicates, for the source cell, at least one of: a physical cell identifier, an operating frequency and a global cell identifier,
the third indication is indicated by a timeSinceL1L2mobility IE,
the fourth indication is indicated by a previousCellType IE,
the fifth indication is indicated by a targetL1L2Configured IE, and
the sixth indication is indicated by a timeSinceL1L2Configuration IE.

24. The method according to claim 21, further comprising one or more of:
receiving the previous indication,
performing, responsive to the received previous indication, the mobility procedure from the first network node to the second network node,
declaring the failure in the mobility procedure, and
storing any of the one or more indications responsive to the declared failure, and wherein the sent one or more indications are the stored one or more indications.

25. A method performed by a third network node, for handling a failure in a mobility procedure by the wireless device from a first network node to a second network node, the third network node operating in a wireless communications network, the method comprising:
receiving, from the wireless device, one or more indications indicating the failed mobility procedure, the one or more indications comprising at least a first indication indicating whether a previous indication that indicated to the wireless device to perform a last completed mobility procedure was received by the wireless device via a Layer 1/Layer 2 (L1/L2) operation or via a Layer 3 (L3) operation.

26. The method according to claim 25, wherein the one or more indications further comprise at least one of:
a second indication indicating a source cell in which the previous indication to perform the last completed mobility procedure was received,
a third indication indicating a time elapsed between a first time of execution of the last completed mobility procedure and a second time when the failure in the last completed mobility procedure was declared.
a fourth indication indicating whether a target cell in which the last completed mobility procedure was executed was a) a secondary cell (SCell), b) a primary secondary cell (PSCell), or c) a non-serving candidate cell, while connected to a source primary cell (Pcell),
the fourth indication, further indicating the target cell in which the last completed mobility procedure was executed was an SCell associated to a Master Cell Group (MCG) or an SCell associated to a Secondary Cell Group (SCG),
a fifth indication indicating whether the wireless device was configured for L1/L2 inter-cell mobility procedure while connected to the target cell at the second time when the failure in the last completed mobility procedure was declared,
a sixth indication indicating a third time elapsed between a storage of information indicating the last completed mobility procedure and the first time of execution of the last completed mobility procedure, or the second time when the failure, in the mobility procedure was declared, and
a seventh indication indicating whether the last completed mobility procedure was performed based on a conditional configuration or not.

27. The method according to claim 26, wherein at least one of:
the one or more indications are sent in a report,
the one or more indications are sent in a UEInformationResponse message,
the failure is a radio link failure,
the mobility procedure is an L1/L2 inter-cell mobility procedure,
the first indication is indicated by a lastHO-Type information element (IE) set to I1-I2Mobility procedure,
the first indication comprises a lastHO-Type IE set to I1-I2Mobility,
with the proviso the previous indication was received via L1, the first indication is indicated by an I1-I2Trigger set to 11Trigger,
with the proviso the previous indication was received via L2, the first indication is indicated by an I1-I2Trigger IE set to I2Trigger,
the second indication is indicated by a previousL1L2Cell IE,
the second indication indicates, for the source cell, at least one of: a physical cell identifier, an operating frequency and a global cell identifier,
the third indication is indicated by a timeSinceL1L2mobility IE,
the fourth indication is indicated by a previousCellType IE,
the fifth indication is indicated by a targetL1L2Configured IE, and
the sixth indication is indicated by a timeSinceL1L2Configuration IE.

28. The method according to claim 25, further comprising:
determining, based on the received one or more indications, a type of operation that triggered the last completed mobility procedure, and
sending, based on a result of the determination, a further indication of the failed mobility procedure to an entity managing the operation, out of the L1/L2 operation and the L3 operation, that triggered the last completed mobility procedure.

29. The method according to claim 28, wherein at least one of:
with the proviso that the last completed mobility procedure was triggered by the L1/L2 operation, the entity is a distributed unit comprised in the third network node, and
with the proviso that the last completed mobility procedure was triggered by the L3 operation, the entity is a central unit comprised in the third network node.

30. The method according to claim 26, further comprising one or more additional determinations of determining a type of cell in which the failure occurred and/or determining how long the wireless device had stored a configuration for the last completed mobility procedure associated to a candidate cell, and wherein the sending of the further indication further comprises one or more additional indications indicating a result of the one or more additional determinations.

31. A wireless device, for handling a failure in a mobility procedure by the wireless device from a first network node to a second network node, the wireless device being configured to operate in a wireless communications network, the wireless device comprising:
radio circuitry; and
processing circuitry configured to send, to a third network node serving the wireless device in the wireless communications network, one or more indications configured to indicate the failed mobility procedure, the one or more indications being configured to comprise at least a first indication configured to indicate whether a previous indication that indicated to the wireless device to perform a last completed mobility procedure was received by the wireless device via a Layer 1/Layer 2 (L1/L2) operation or via a Layer 3 (L3) operation.

32. The wireless device according to claim 31, wherein the one or more indications comprise at least one of:
a second indication configured to indicate a source cell in which the previous indication to perform the last completed mobility procedure was received,
a third indication configured to indicate a time elapsed between a first time of execution of the last completed mobility procedure and a second time when the failure in the last completed mobility procedure was declared.
a fourth indication configured to indicate whether a target cell in which the last completed mobility procedure was executed was a) a secondary cell (SCell), b) a primary secondary cell (PSCell), or c) a non-serving candidate cell, while connected to a source primary cell (Pcell),
the fourth indication, further configured to indicate the target cell in which the last completed mobility procedure was executed was an SCell associated to a Master Cell Group (MCG) or an SCell associated to a Secondary Cell Group (SCG),
a fifth indication configured to indicate whether the wireless device was configured for L1/L2 inter-cell mobility procedure while connected to the target cell at the second time when the failure in the last completed mobility procedure was declared,
a sixth indication configured to indicate a third time elapsed between a storage of information indicating the last completed mobility procedure and the first time of execution of the last completed mobility procedure or the second time when the failure in the mobility procedure was declared, and
a seventh indication configured to indicate whether the last completed mobility procedure was performed based on a conditional configuration or not.

33. The wireless device according to claim 32, wherein at least one of:
the one or more indications are sent in a report,
the one or more indications are sent in a UEInformationResponse message,
the failure is a radio link failure,
the mobility procedure is an L1/L2 inter-cell mobility procedure,
the first indication is indicated by a lastHO-Type information element (IE) set to I1-I2Mobility,
the first indication is a lastHO-Type IE set to I1-I2Mobility,
with the proviso the previous indication was received via L1, the first indication is indicated by an I1-I2Trigger set to I1Trigger,
with the proviso the previous indication was received via L2, the first indication is indicated by an I1-I2Trigger IE set to I2Trigger,
the second indication is indicated by a previousL1L2Cell IE,
the second indication indicates, for the source cell, at least one of: a physical cell identifier, an operating frequency and a global cell identifier,
the third indication is indicated by a timeSinceL1L2mobility IE,
the fourth indication is indicated by a previousCellType IE,
the fifth indication is indicated by a targetL1L2Configured IE, and
the sixth indication is indicated by a timeSinceL1L2Configuration IE.

34. The wireless device according to claim 31, the processing circuitry further configured to one or more of:
receive the previous indication,
perform, responsive to the previous indication, the mobility procedure from the first network node to the second network node,
declare the failure in the mobility procedure, and
store any of the one or more indications responsive to the declared failure, and wherein the one or more indications sent are the one or more indications stored.

35. A third network node, for handling a failure in a mobility procedure by the wireless device from a first network node to a second network node, the third network node being configured to operate in a wireless communications network, the third network node comprising:
processing circuitry configured to receive, from the wireless device, one or more indications configured to indicate the failed mobility procedure, the one or more indications being configured to comprise at least a first indication configured to indicate whether a previous indication that indicated to the wireless device to perform a last completed mobility procedure was received by the wireless device via a Layer 1/Layer 2 (L1/L2) operation or via a Layer 3 (L3) operation.

36. The third network node according to claim 35, wherein the one or more indications comprise at least one of:
a second indication configured to indicate a source cell in which the previous indication to perform the last completed mobility procedure was received,
a third indication configured to indicate a time elapsed between a first time of execution of the last completed mobility procedure and a second time when the failure in the last completed mobility procedure was declared,
a fourth indication configured to indicate whether a target cell in which the last completed mobility procedure was executed was a) a secondary cell (SCell), b) a primary secondary cell (PSCell), or c) a non-serving candidate cell, while connected to a source primary cell (Pcell),
the fourth indication, further configured to indicate the target cell in which the last completed mobility procedure was executed was an SCell associated to a Master Cell Group (MCG) or an SCell associated to a Secondary Cell Group (SCG),
a fifth indication configured to indicate whether the wireless device was configured for L1/L2 inter-cell mobility procedure while connected to the target cell at the second time when the failure in the last completed mobility procedure was declared,
a sixth indication configured to indicate a third time elapsed between a storage of information indicating the last completed mobility procedure and the first time of execution of the last completed mobility procedure, or the second time when the failure, in the mobility procedure was declared, and
a seventh indication configured to indicate whether the last completed mobility procedure was performed based on a conditional configuration or not.

37. The third network node according to claim 36, wherein at least one of:
the one or more indications are sent in a report,
the one or more indications are sent in a UEInformationResponse message,
the failure is a radio link failure,
the mobility procedure is an L1/L2 inter-cell mobility procedure,
the first indication is indicated by a lastHO-Type information element (IE) set to I1-I2Mobility procedure,
the first indication comprises a lastHO-Type IE set to I1-I2Mobility,
with the proviso the previous indication was received via L1, the first indication is indicated by an I1-I2Trigger set to I1Trigger,
with the proviso the previous indication was received via L2, the first indication is indicated by an I1-I2Trigger IE set to I2Trigger,
the second indication is indicated by a previousL1L2Cell IE,
the second indication indicates, for the source cell, at least one of: a physical cell identifier, an operating frequency and a global cell identifier,
the third indication is indicated by a timeSinceL1L2mobility IE,
the fourth indication is indicated by a previousCellType IE,
the fifth indication is indicated by a targetL1L2Configured IE, and
the sixth indication is indicated by a timeSinceL1L2Configuration IE.

38. The third network node according to claim 35, wherein the processing circuitry is further configured to:
determine, based on the one or more indications configured to be received, a type of operation that triggered the last completed mobility procedure, and
send, based on a result of the determination, a further indication of the failed mobility procedure to an entity managing the operation, out of the L1/L2 operation and the L3 operation, that triggered the last completed mobility procedure.

39. The third network node according to claim 38, wherein at least one of:
with the proviso that the last completed mobility procedure was triggered by the L1/L2 operation, the entity is configured to be a distributed unit comprised in the third network node, and
with the proviso that the last completed mobility procedure was triggered by the L3 operation, the entity is configured to be a central unit comprised in the third network node.

40. The third network node according to claim 36, the processing circuitry further configured to perform one or more additional determinations of determining a type of cell in which the failure occurred and determining how long the wireless device had stored a configuration for the last completed mobility procedure associated to a candidate cell, and wherein the processing circuitry is configured to send one or more additional indications configured to indicate a result of the one or more additional determinations.
